(19) United States
(12) Patent Application Publication
(10) Pub. No.: US 2004/0107239 A1
(43) Pub. Date: Jun. 3, 2004

(54) Program and method for supporting inquiries from server to operator

(75) Inventors: Toshitaka Hasegawa, Aichi (JP); Akinobu Noda, Aichi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/721,543

(22) Filed: Nov. 26, 2003

(30) Foreign Application Priority Data
Nov. 28, 2002 (JP) 2002-344908

(51) Int. Cl. G06F 15/16

(52) U.S. Cl. 709/200

(57) ABSTRACT

An inquiry, support program that helps a server receive instructions from an operator, reducing the possibilities for the operator to return a wrong response. When a service process issues an inquiry to the operator, the server stores the inquiry in an inquiry buffer (step S1). The server receives a first delivery request from a first client on the network, which causes the inquiry pending in the inquiry buffer to be retrieved and sent to the first client over the network (step S2). At the first client, the operator answers the inquiry. Upon receipt of the reply from the first client, the server passes it to the requesting service process, as well as storing the original inquiry and corresponding reply in a log memory (step S3). When a second delivery request is received from a second client on the network, the server retrieves log records from the log memory and sends them to the requesting second client (step S4).

### BACKGROUND OF THE INVENTION

1. Field of the Invention

The present invention relates to a program and method for helping service processes in a server to receive information from other stations. More particularly, the present invention pertains to an inquiry support program and method that support a process of issuing inquiries from service processes and receiving replies from an operator.

2. Description of the Related Art

Client-server systems are widely used today. Server programs running on a server computer (or simply “server”) provide various services to a plurality of client computers (or simply “clients”) in response to their demands. Generally, server programs are designed to offer a requested service according to a predetermined sequence of processing steps. Servers are supposed to continue their services, performing most tasks without operator intervention.

The exception is that server programs sometimes need to be reconfigured, even in the middle of operation, to ensure the reliability of service. For example, a server program may encounter such a situation where it needs an instruction from the system operator before proceeding to the next stage of service. Based on the operation instruction, the server program decides which way to go. In this situation, the ongoing process on the server has to actively interact with the operator console, displaying messages and prompting the operator to answer. The interaction between a server and operator requires a set of user interface functions, but it is generally impractical to install such modules in each server program. Conventional servers therefore provide a mechanism for a server program to communicate with the operator, which is a macro instruction known as “write-to-operator with reply (WTOR).”

FIG. 25 shows the concept of how WTOR macro instructions work in a conventional client-server system. The illustrated system involves a server 910 and an operator console 920 connected to it. Actually, one or more processes or tasks are running on the server 910 to offer intended functions or services. In this description we will refer to those server processes or tasks as “service processes.”

Referring to the system of FIG. 25, the server 910 has an active service process 911 and a message display processor 912 as part of its processing modules. The service process 911 provides functions described in a server program. The message display processor 912 sends WTOR messages to the operator console 920 when the server program uses WTOR macro instructions. The operator console 920, on the other hand, has a user interface controller 921 to display messages sent from the server 910 and deliver console input such as keyboard data to the server 910.

When it needs an instruction from the operator, the service process 911 issues a WTOR macro instruction, attaching a piece of message text as a parameter. The service process 911 suspends its main service task until it receives a response to the WTOR macro instruction it has issued. The message display processor 912 assigns a message identifier for this WTOR macro instruction and sends an inquiry message with that message identifier to the operator console 920.

On the operator console 920, the user interface controller 921 displays the delivered message text and its corresponding message identifier on a monitor screen. The operator checks the message on the screen and then enters an answer to the operator console 920, as well as typing the message identifier, using the keyboard and other input devices. The operator console 920 sends the entered reply data to the server 910.

In the server 910, the received reply message is directed to the service process 911, which originated the WTOR macro instruction. Now that an operator input is obtained, the service process 911 resumes its task according to what the operator has instructed. For more details about this WTOR mechanism, refer to, for example, “OSIV/MSP System Programming Manual (Task Management) for AFII V10 OS IV/MSP,” Fourth Edition, Fujitsu LIMITED, June, 2000 (original in Japanese). Particularly relevant are: Chapter 14, “Operator-Program Communications” and Section 14.1.5, “Functions of WTOR Macro instruction.”

One drawback of the conventional method using a WTOR macro is that the operator is likely to make a mistake in writing an answer. That is, server programs expect the operator to enter a character string in a predefine format that they require, which, however, can easily be violated due to the respondent's simple typing errors. Such a formal error on the operator's part makes it impossible for the service process 911 to proceed with the next step because it is unable to parse the given reply. Suppose, for example, that the operator has entered an incorrect message identifier. This error causes the reply message to be delivered not to the intended service process 911, but to some other service process, thus disrupting the computing task that the service process 911 is pursuing.

Conventional server programs could encounter similar difficulties when the operator's answer has a syntactical error, which would confuse the service process 911 in analyzing the message. Think of, for example, an inquiry as to whether some event has happened or not. Possible answers may be “yes”/“no” or “true”/“false” or something else. Even for a simple question like this, there is more than one way to answer. The answer cannot be parsed if it is not written in the way intended by the requesting service process 911.

Once having issued an inquiry, the requesting service process has to wait until an answer is returned in a correct way. But staying too long in such a state is wasting precious computer resources (e.g., memory and disk space). Besides slowing down the server 910, the presence of locked service processes could invite other serious problems in the operations of the server 910.

### SUMMARY OF THE INVENTION

In view of the foregoing, the present invention discloses an inquiry support program and method that prevent an operator from returning a wrong reply in response to an inquiry message from a server.

In one aspect of the present invention, a program product that helps service processes receive instructions from an operator is provided. This program product causes a computer system to perform a process comprising the following steps: (a) storing an inquiry to the operator in an inquiry buffer, upon issuance thereof from a service process; (b) retrieving the inquiry pending in the inquiry buffer and sending the retrieved inquiry to the first client over a network, in response to a first delivery request from a first client; (c) forwarding a reply received from the first client to the service process, as well as storing the received reply and corresponding inquiry as a log record in a log memory; and (d) retrieving log records from the log memory and sending the retrieved log records to a second client on the network, in response to a second delivery request from the second client.

In another aspect of the present invention, a method that helps service processes receive instructions from an operator is provided. This method comprises the following steps: (a) storing an inquiry to the operator in an inquiry buffer, upon issuance thereof from a service process; (b) retrieving the inquiry pending in the inquiry buffer and sending the retrieved inquiry to the first client over a network, in response to a first delivery request from a first client; (c) forwarding a reply received from the first client to the service process, as well as storing the received reply and corresponding inquiry as a log record in a log memory; and (d) retrieving log records from the log memory and sending the retrieved log records to a second client on the network, in response to a second delivery request from the second client.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the concept of a method in which the present invention is embodied.

FIG. 2 shows an example of a network system according to the present embodiment.

FIG. 3 shows an example of a computer hardware platform on which the present invention is embodied.

FIG. 4 is a block diagram which shows the functional structure of a client-server system according to the present embodiment.

FIG. 5 shows an example of an inquiry message listing screen.

FIG. 6 shows an example of a log listing screen.

FIG. 7 shows an example of a reply log listing screen.

FIG. 8 is a sequence diagram showing how log records are displayed.

FIG. 9 explains a concept of how the operator chooses an answer from a list of possible answers.

FIG. 10 shows an example of a reply dialog box with an answer list.

FIG. 11 shows an example of a reply dialog box for free text input.

FIG. 12 is a sequence diagram which shows a procedure of multiple-choice selection.

FIG. 13 is a conceptual view of a process that produces a reply message by selecting one of the reply log records.

FIG. 14 shows an example of a reply log listing screen.

FIG. 15 is a functional block diagram of a server with timeout processing functions.

FIG. 16 shows an example of a timeout period table.

FIG. 17 shows an example of timeout processing using a timeout period table.

FIG. 18 is a sequence diagram showing a procedure of timeout processing.

FIG. 19 shows an example of data structure of an inquiry buffer.

FIG. 20 shows a specific example of data stored in the inquiry buffer.

FIG. 21 shows an example of data structure of a log memory.

FIG. 22 shows a specific example of data stored in the log memory.

FIG. 23 is a conceptual view of a process which executes a command according to a given reply.

FIG. 24 is a sequence diagram of a process that dispatches a command according to a given reply.

FIG. 25 shows the concept of how WTOR macro instructions work in a conventional client-server system.

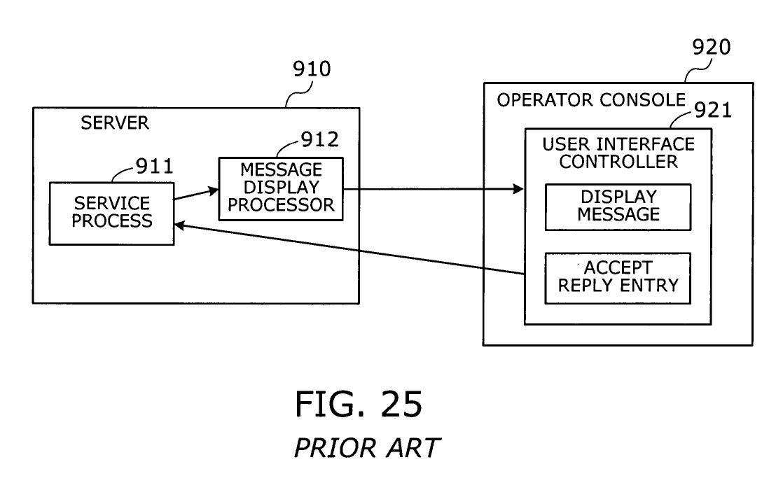

### DESCRIPTION OF THE PREFERRED EMBODIMENTS

Preferred embodiments of the present invention will be described below with reference to the accompanying drawings, wherein like reference numerals refer to like elements throughout. The following description will first outline the invention and then give a more specific explanation for how the invention will be implemented.

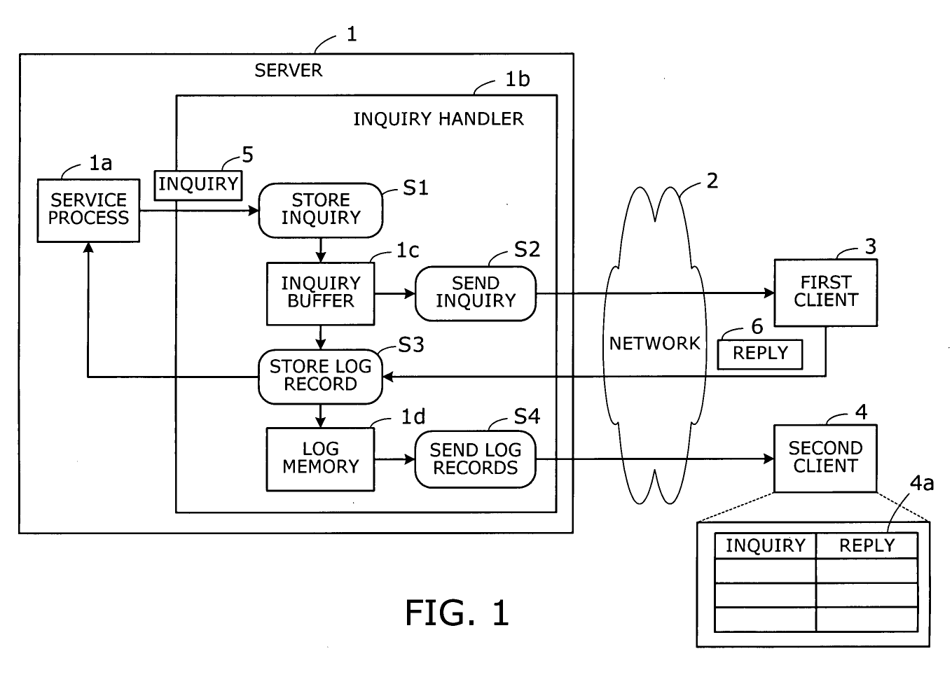

FIG. 1 shows the concept of an inquiry support program in which the present invention is embodied. The inquiry support program of the present invention is intended for aiding a service process 1a to receive a reply to an inquiry that it sent to the operator. The service process 1a is part of a computer system that offers data processing and other services. This computer system, called a server 1, executes the inquiry support program of the invention, thereby functioning as an inquiry handler 1b. More specifically, the inquiry handler 1b executes the tasks described below.

The service process la sometimes needs information from or intervention by the operator in the course of a specific service. When such an event happens, the service process 1a issues an inquiry 5 to the operator and stops execution of the service. Upon receipt of the inquiry 5 from the service process 1a, the inquiry handler 1b saves it in an inquiry buffer 1c (step s1). After that, in response to a request from the first client 3 that requires delivery of pending inquiries, the inquiry handler 1b retrieves the inquiry 5 in the inquiry buffer 1c and sends it to the first client 3 over the network 2 (step s2).

The operator using a first client 3 gives an input in response to the received inquiry 5, and the first client 3 sends it to the server 1 as a reply 6 to the inquiry 5. Upon receipt of the reply 6 from the first client 3, the inquiry handler 1b stores the original inquiry 5 and received reply 6 in a log memory 1d in an associative way, as well as passing the reply 6 to the requesting service process 1a (step S3). The information in this log memory 1d is referred to as log records. With the reply 6 received, the service process 1a resumes the service task that has been suspended since the issuance of the inquiry 5.

FIG. 1 shows another client on the same network 2. This second client 4 requests the server 1 to deliver log records, which causes the inquiry handler 1b to retrieve relevant log records from the log memory 1d and sends them back to the requesting second client 4 (step S4). Upon receipt of those log records, the second client 4 produces a log listing screen 4a to show the log records of inquiries and replies.

The above inquiry support program, when executed on a computer platform, stores log records including past inquiries and their corresponding replies. When a delivery request for such log records is received, the server 1 sends stored log records to the second client 4, allowing the operator of the second client 4 to browse them on a log listing screen 4a and learn how they were answered in the past similar cases. Records of such past replies help the operator write an answer to the present enquiry. That is, he/she can reply to the present inquiry more easily and correctly by following the way the past inquiries were answered. The inquiry support program thus reduces the chance for him/her to use a wrong format or make other mistakes when answering an inquiry.

The first client 3 may receive a plurality of inquiries at a time. If this is the case, the first client 3 displays a list of those inquiries on a monitor screen, which allows the operator to choose one of them and write a reply 6 to it. The first client 3 never requires the operator to retype the identifier of an inquiry to select it, thus preventing him/her from making a mistake such as entering a wrong number.

While FIG. 1 illustrates the first and second clients 3 and 4 as separate units, the present invention is not restricted to that specific arrangement. The functions of those two clients 3 and 4 may actually be implemented on a single client computer.

According to the present invention, the inquiry handler 1b shown in FIG. 1 has all or part of the following functions:

(a) When the second client 4 requires delivery of log records, specifying particular search conditions, the inquiry handler 1b retrieves and sends such log records that match with the specified conditions. This function enables the second client 4 to display, for example, a list of log records of such inquiries that were answered during a particular period.

(b) When the second client 4 requires delivery of message log records, the inquiry handler 1b retrieves sends records including inquiry-related information (e.g., message, date). This feature enables the operator using the second client 4 to browse the records of past inquiries for reference purposes.

(c) When the second client 4 requires delivery of reply log records, the inquiry handler 1b retrieves and sends records including reply-related information to the requesting client 4. This function is helpful for the operator in the case he/she already has a particular inquiry of interest and wishes to see, for reference purposes, past replies that were made to similar inquiries.

(d) When the second client 4 requires delivery of reply log records concerning a specific inquiry, the inquiry handler 1b retrieves log records of similar inquiries (e.g., those having the same message text) and provides the information about what replies were made to those past inquiries. This function permits the operator using the second client 4 to selectively browse the records of replies made to past similar inquiries.

(e) When delivering a pending inquiry to the first client 3, the inquiry handler 1b may add an answer list to that inquiry. More specifically, each inquiry has a reply method identifier, and in the case that the identifier indicates that a multiple-choice selection should be made, the inquiry handler 1b attaches a list of possible answers to the inquiry, thus causing the first client 3 to display two or more choices of answers on a monitor screen. The operator selects one answer from among those in the on-screen list, and it is returned to the requesting server 1. This function enables the operator using the first client 3 to give an appropriate answer by selecting one of predefined choices, with little possibility of making a mistake in answering the inquiry.

(f) When delivering a pending inquiry to the first client 3, the inquiry handler 1b may retrieve log records of similar inquiries and sends the replies made to those past inquiries, together with the pending inquiry. This function permits the operator using the first client 3 to consult the records of past replies, thus reducing the chance of making a mistake in answering the present inquiry.

(g) If there is no reply within a predetermined timeout period, the inquiry handler 1b notifies the requesting service process 1a of the cancellation of its pending inquiry. This function prevents the service process 1a from wasting too much time in expectation of receiving a reply.

(h) The inquiry handler 1b can use a timeout period specified in an inquiry itself. Expiration time of an inquiry is calculated by adding the specified timeout period to the inquiry's issuance time. If this expiration time is reached before an answer returns, the inquiry handler 1b notifies the requesting service process 1a of the cancellation of its pending inquiry. Thus the service process 1a has only to add a timeout period parameter to an inquiry when issuing it. With this feature, programmers can develop service processes more easily.

(i) Timeout period may be specified indirectly by using timeout period identifiers, of inquiries, and in this case, the inquiry handler 1b calculates an expiration time with reference to a predefined timeout period table that associates a plurality of timeout period identifiers with corresponding timeout period values. Besides allowing the service process 1a to vary the timeout period from inquiry to inquiry, this function permits the inquiry handler 1b to give a specific time length to each group of inquiries having a particular timeout period identifier. Timeout periods can thus be set dynamically in accordance with variations in the processing load of the server 1 or other parameters affecting the system environment.

(j) A command may previously be associated with a pending inquiry so that a particular processing task related to the inquiry will be executed automatically. The inquiry handler 1b dispatches such a command, if any, upon receipt of a reply from the first client 3. Besides resuming a pending service process 1a, this feature makes it possible to invoke various post-inquiry tasks, such as sending an email message to the system administrator to inform him/her of the reply.

(k) When dispatching a post-inquiry command, the inquiry handler 1b may add the received reply as a parameter of the command to be dispatched. This feature is used in, for example, creating an email message that informs someone of the reply.

The above functions of the inquiry handler 1b are implemented in the embodiments of the present invention as will be described in detail in the following sections.

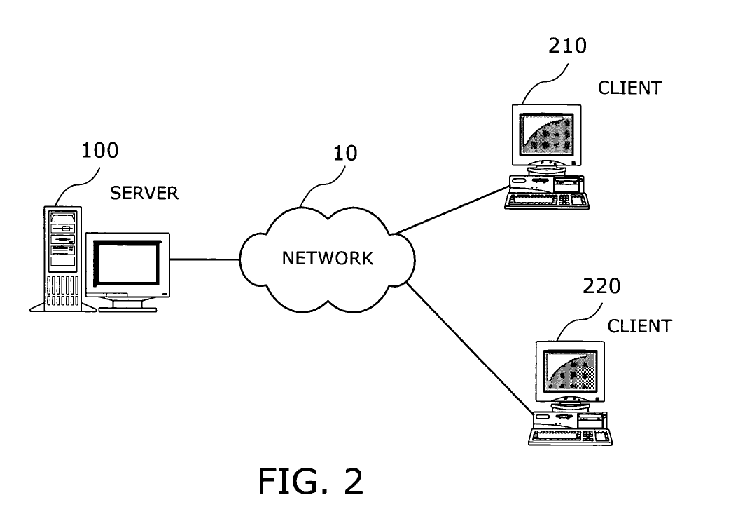

FIG. 2 shows an example of a network system according to the present embodiment. A server 100 is connected to a plurality of clients 210 and 220 on a network 10.

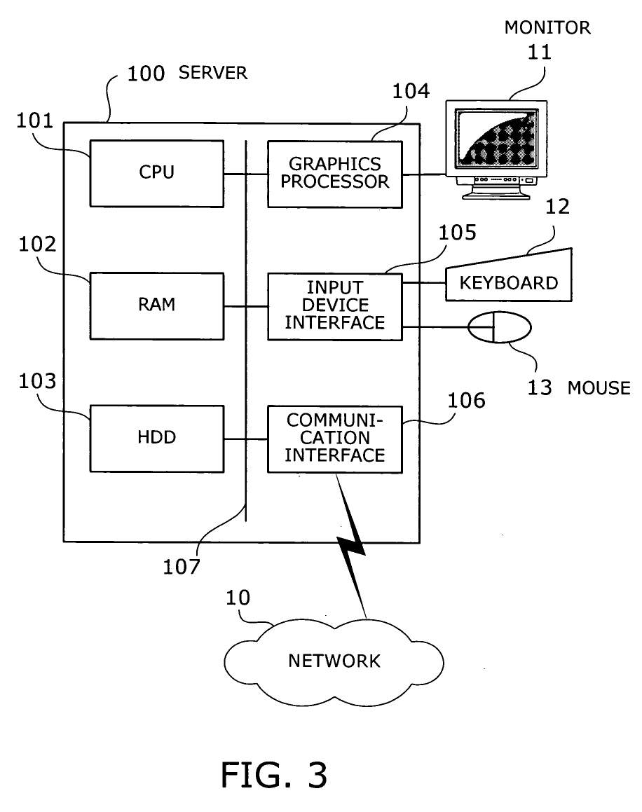

FIG. 3 shows an example of a computer hardware platform on which the present invention is implemented. The illustrated server 100 has the following circuit elements: a central processing unit (CPU) 101, a random access memory (RAM) 102, a hard disk drive (HDD) 103, a graphics processor 104, an input device interface 105, and a communication interface 106. The CPU 101 controls the entire system of the server 100, interacting with other elements via a common bus 107. The RAM 102 temporarily stores the whole or part of operating system (OS) programs and application programs that the CPU 101 executes, in addition to other various data objects manipulated at runtime. The HDD 103 stores program and data files of the operating system and various applications.

The graphics processor 104 produces video images in accordance with drawing commands from the CPU 101 and displays them on the screen, of an external monitor 11 coupled thereto. The input device interface 105 is used to receive signals from external input devices, such as a keyboard 12 and a mouse 13. Input signals are supplied to the CPU 101 via the bus 107. The communication interface 106 is connected to a network 10, allowing the CPU 101 to exchange data with other computers (not shown) on the network 10.

The functions of the present invention can be embodied with the above-described hardware structure. While FIG. 3 illustrates a typical platform for the server 100, the same or similar hardware structure may also be applied to the clients 210 and 220.

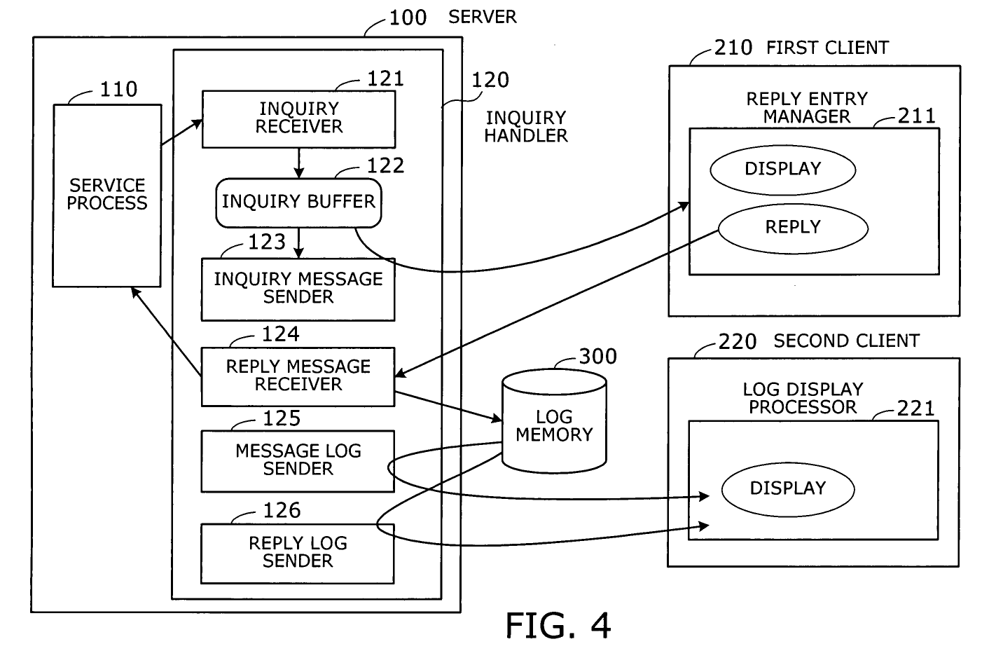

FIG. 4 is a block diagram which shows the functional structure of a client-server system according to the present embodiment. In this system of FIG. 4, the operator uses a first client 210 to respond to inquiries and a second client 220 to browse various log records. The server 100 has, among others, a service process 110 and an inquiry handler 120. The inquiry handler 120 has an inquiry receiver 121, an inquiry buffer 122, an inquiry message sender 123, a reply message receiver 124, a message log sender 125, and a reply log sender 126. A log memory 300 is connected to the server 100.

The service process 110 is actually one of the processing functions that the server 100 (server computer) provides through its execution of a server program. More precisely, the service process 110 refers to a collection of one or more processes (tasks) that constitutes the server program. In normal operation, the service process 110 provides a service in response to a request from the clients 210 and 220, as well as from other clients not shown in FIG. 4. The service process 110 may also be called up by the operating system and provide, the requested service to it. If it encounters a predefined event that needs operator intervention, the service process 110 suspends the current process and sends an inquiry to the operator. Suppose, for example, that the service process 110 needs an instruction from the operator. Then the service process 110 produces a piece of text (message text) that is intended for display on a client screen and invokes an inquiry API call including the message as a parameter, where API stands for “application program interface.” When a reply to this inquiry is returned, the service process 110 resumes the pending process with an appropriate procedure according to the reply.

Message text, sent as a parameter of an inquiry API call, indicates what and how the operator is supposed to respond. The message says, for example, “Who is the contact person?” or “Select the place you are visiting for business.”

The inquiry handler 120 helps the service process 110 obtain a reply from the operator. The following will describe the function of each element of the inquiry handler 120.

The inquiry receiver 121 receives an inquiry API call from the service process 110. The inquiry receiver 121 then stores the inquiry (i.e., the information contained in the received inquiry API call) in the inquiry buffer 122. The inquiry buffer 122, serving here as temporary storage for such inquiry information, may be implemented as, for example, a part of memory space of the RAM 102 shown in FIG. 3.

When so requested by the first client 210, the inquiry message sender 123 retrieves each inquiry pending in the inquiry buffer 122 and produces an inquiry message based on that information. The inquiry message sender 123 then sends the produced inquiry message to the first client 210.

The reply message receiver 124 receives a reply from the first client 210. The reply message receiver 124 saves a log record concerning this inquiry session in the log memory 300, as well as passing the received reply to the requesting service process 110. Each log record in the log memory 300 consists of several pieces of information, including those about an inquiry and those about a reply. The inquiry-related log information (e.g., message text, transmission date of inquiry message) is referred to as “message log records.” On the other hand, the reply-related log information (e.g., reply data, reception date of reply message) is referred to as “reply log records.” The message log sender 125 reads message log records out of the log memory 300 and sends them to the second client 220 when so requested by the second client 220. Similarly, the reply log sender 126, reads reply log records out of the log memory 300 for delivery to the second client 220 when so requested by the second client 220.

The first client 210 has a reply entry manager 211. The reply entry manager 211 is a user interface that displays received inquiry messages on the monitor screen and accepts console input from the respondent who answers inquiries. More specifically, with the inquiry messages received from the server 100, the reply entry manager 211 produces an inquiry message listing screen to display the content of those inquiry messages. Also, when a reply is entered by the operator, the reply entry manager 211 sends it to the server 100 as a response to one of the received inquiry messages.

The second client 220 has a log display processor 221, which is a user interface that requests, in response to console input from the operator, the server 100 to deliver log records. The request may be for either message log records or reply log records or both. Upon receipt of such log records from the server 100, the log display processor 221 produces a reply log screen to display the content of the received records.

The log memory 300 is a storage medium to keep log records of transmitted inquiry messages and their corresponding replies. Specifically, a part of the HDD 103 shown in FIG. 3 may be allocated for use as the log memory 300.

The system illustrated in FIG. 4 operates as follows. It is supposed here that the service process 110 in the server 100 is called up to provide a client with processing services as requested. In normal operation, the service process 110 is responsive to requests from the clients 210 and 220 shown in FIG. 4, as well as from those not shown in FIG. 4. When it encounters an event that needs an instruction from the operator, the service process 110 produces a piece of message text that is intended for display on a client screen and invokes an inquiry API call including the message text as a parameter. The issuance of this API call causes the inquiry receiver 121 to extract its parameters such as message text for inquiry and puts them into the inquiry buffer 122.

The reply entry manager 211 running on the first client 210 sends a delivery request to the inquiry message sender 123 over the network, thus collecting inquiry messages. In response to this delivery request from the reply entry manager 211, the inquiry message sender 123 retrieves pending inquiries out of the inquiry buffer 122. They inquiry message sender 123 then compiles inquiry messages from the obtained data and sends them to the reply entry manager 211 in the first client 210.

The reply entry manager 211 produces an inquiry message listing screen to display all the inquiry messages received from the inquiry message sender 123. From among those displayed in the inquiry message listing screen, the operator chooses one message that he/she is going to respond to and enters reply data for that inquiry. This operator input enables the reply entry manager 211 to respond to the selected inquiry message by sending the entered reply data to the reply message receiver 124.

Upon receipt of the reply message from the client 210, the reply message receiver 124 hands it over to the service process 110, and at the same time, it saves a log record in the log memory 300, which includes message text, reply data, reply date, and other related items.

On the second client 220, the log display processor 221 requests, through a network, the message log sender 125 to deliver message log records. The message log sender 125 in the server 100 then retrieves log records (message text, reply data, reply date, and other related information) out of the log memory 300. The message log sender 125 selectively delivers message log records to the log, display processor 221, extracting inquiry message text and the like from the retrieved log records. This causes the log display processor 221 to display a reply log screen on the monitor of the second client 220, which shows the content of message log records.

The operator at the second client 220 selects one of the message log records displayed in the reply log screen and requests reply log records concerning the past inquiry that he/she has selected. The log display processor 221 passes this request to the reply log sender 126 over the network, transmitting a delivery request for reply log records that are relevant to the selected message log record.

In the server 100, the reply log sender 126 searches the log memory 300 for log records that include the same message text as the selected message log record. The reply log sender 126 then returns a reply log record of each found log record to the log display processor 221. The log display processor 221 displays a list of received reply log records in the reply log record screen, which indicates what response was made to each past inquiry message.

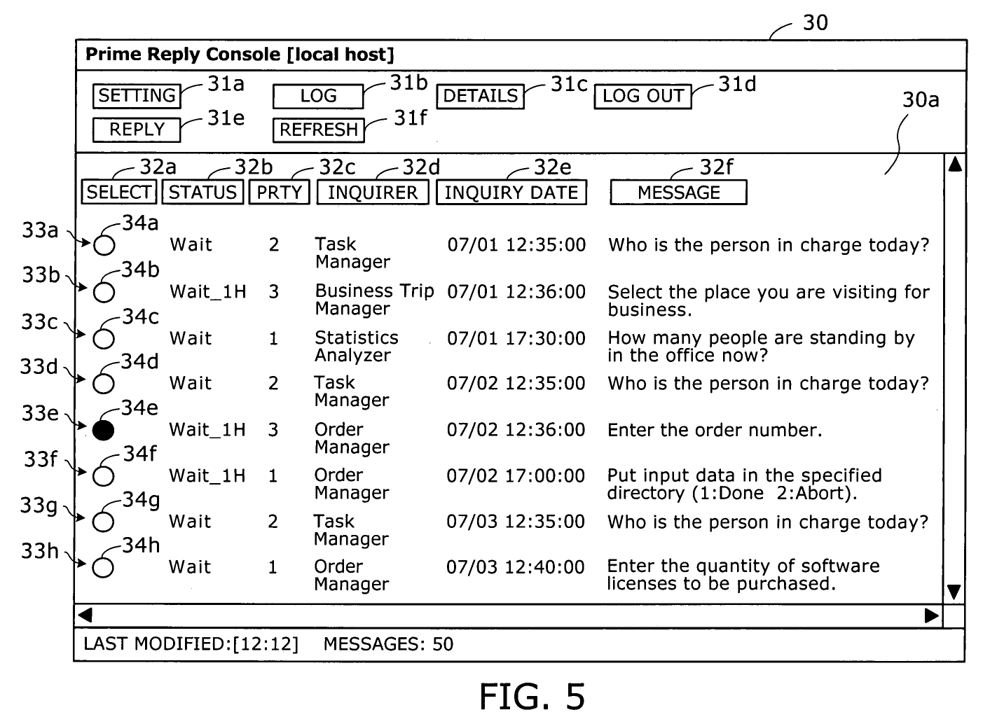

FIG. 5 shows an example of an inquiry message listing screen. The illustrated inquiry message listing screen 30 has an a plurality of command buttons 31a to 31f and an inquiry message listing pane 30a. The command buttons 31a to 31f are used to initiate a particular action to handle inquiry messages displayed on the inquiry message listing pane 30a. The following will explain the function of each command button.

The leftmost command button 31a labeled “SETTING” is used to set how inquiry messages should be formatted on the inquiry message listing screen 30. Pressing this command button 31a causes the reply entry manager 211 to display a format setting dialog box (not shown), on which the operator can specify his/her preferred options about display format.

The second command button 31b labeled “LOG” is used to request the server 100 to provide log records of inquiry messages. Pressing this command button 31b causes a dialog box to pop up on the monitor screen to allow the operator to set search conditions and the like for use in retrieving inquiry message log records. More specifically, the command button 31b invokes a function of the first client 210 that is identical to what we have described as the log display processor 221 in the second client 220. This enables the first client 210 to receive log records from the server 1 and present them to the operator.

The next command button 31c labeled “DETAILS” is used when the operator wishes to view further details of a particular inquiry message. He/she selects an inquiry message on the inquiry message listing pane 30a and presses the DETAILS command button 31c. Then the information on the selected message will appear on the monitor screen.

The rightmost command button 31d labeled “LOG OUT” is used to finish the current session of browsing inquiry messages. Pressing the command button 31d causes the first client 210 to terminate the operation of its local reply entry manager 211.

On the second row, the command button 31e labeled “REPLY” is used to return a reply to a particular inquiry message. Pressing command button 31e calls up a reply entry dialog on the monitor screen.

The command button 31f labeled “REFRESH” is used to get the latest version of inquiry message listing. Pressing the command button 31f causes another delivery request for inquiry messages to be sent from the reply entry manager 211 to the server 100. In response to this request, the inquiry message sender 123 in the server 100 sends back the latest inquiry message list, and the reply entry manager 211 displays the received information in the inquiry message listing pane 30a.

The inquiry message listing pane 30a shows a plurality of inquiry messages 33a to 33h. The information of each inquiry message 33a to 33h is represented in the following fields: selection field 32a, status field 32b, priority field 32c, inquirer field 32d, inquiry date field 32e, and message field 32f. Those fields have the following functions:

The selection field 32a offers check boxes 34a to 34h corresponding to individual inquiry messages 33a to 33h, respectively. Each check box 34a to 34h, when selected by the operator, turns black (as in the fifth check box 34e in FIG. 5), indicating that its corresponding inquiry message is selected.

The status field 32b shows the current status of each inquiry message, which may be, for example, “WAIT” or “WAIT_{—}1H.” “WAIT” means that the requesting service process in the server 100 is in a suspended state, waiting for a reply to its unanswered inquiry. “WAIT_{—}1H” also means that the requesting service process is waiting for a reply, but that if there is no reply in one hour, the service process will resume the process according to predetermined settings.

The priority field 32c shows the priority level of each inquiry message. In the example of FIG. 5, larger values indicate higher priorities. Those priority values are used as a criterion for the operator to determine which inquiry message to answer first.

The inquirer field 32d shows which class of service processes issued the inquiry. Such service classes include: “Task Manager,” “Business Trip Manager,” and “Statistics Analyzer.”

The inquiry date field 32e shows when each inquiry message was issued.

The message field 32f shows the text (character string) of each inquiry message. This text gives a specific question to the operator, such as “Who is the person in charge today?” in the topmost line of FIG. 5.

The above-described inquiry message listing screen 30 pops up on a monitor of the client 210, which allows the operator to specify to which inquiry message to answer, using input devices such as a keyboard or mouse of the first client 210. More specifically, the operator selects a particular inquiry message by clicking a check box associated with that message. In this selection, the operator may take into consideration the status and priority of each inquiry in order to determine which inquiry should be answered first. After making the selection, the operator presses the “REPLY” command button 31e, thereby moving to a reply entry dialog box. The operator gives an input in this dialog box, which causes the first client 210 to send to the server 100 a reply to the selected inquiry message.

Inquiry messages may contain a set of choices for reply, which would help the respondent to enter his/her answer in the correct form. See, for example, the sixth inquiry message in FIG. 5, the text of which reads “Put input data in the specified directory (1:Done 2:Abort).” The text in the parentheses suggest that the respondent is supposed to be choose either “1” (done) or “2” (abort).

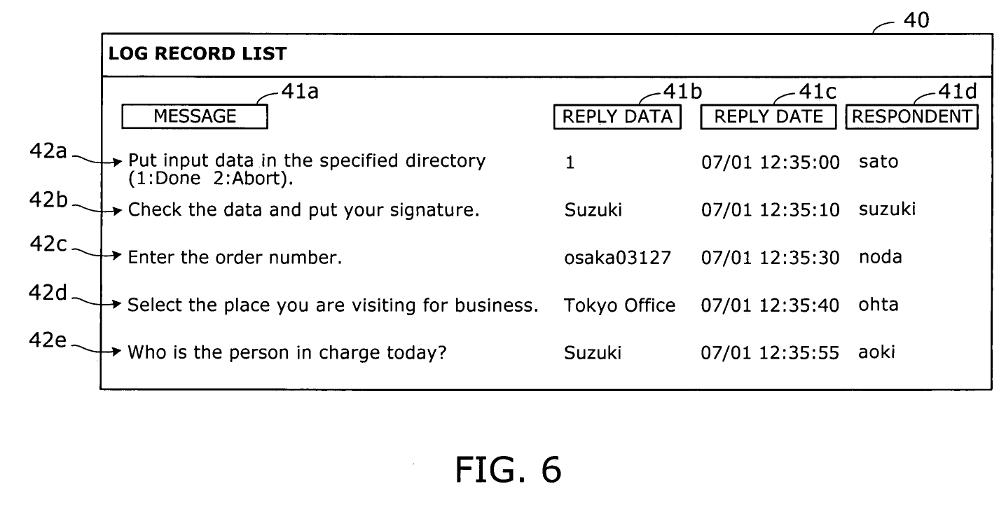

As a further aid, the log display processor 221 may display a log listing screen so that the operator can view past replies for reference. FIG. 6 shows an example of this log listing screen. The illustrated log listing screen 40 gives message log records of inquiry messages that were answered at 12:35 on July 1. That is, FIG. 6 shows the result of a search for log records with a particular time stamp of “07/01 12:35.” Message log records that match with this search criterion are extracted from the log memory 300 and displayed in the log listing screen 40.

The log listing screen 40 of FIG. 6 actually shows a plurality of message log records 42a to 42e retrieved from the log memory 300, each of which consists of the following information fields: message field 41a, reply data field 41b, reply date field 41c, and respondent name field 41d. The message field 41a shows message text of each retrieved message log record. The reply data field 41b tells what answer was returned to each inquiry message. The reply date field 41c shows when the reply was returned, and the respondent name field 41d shows who wrote that reply.

As can be seen from the above, the proposed system offers a log listing screen 40 showing message log records, so that the operator can view the past replies for reference. This function permits the operator to consult example replies that were made correctly in the past, thus reducing the chance of making a mistake in answering an inquiry from the server 100. Further, by selecting an inquiry message from the log listing screen 40, the operator can call up a reply log listing screen containing the records of replies that were made to past inquiries having the same message text as the selected one.

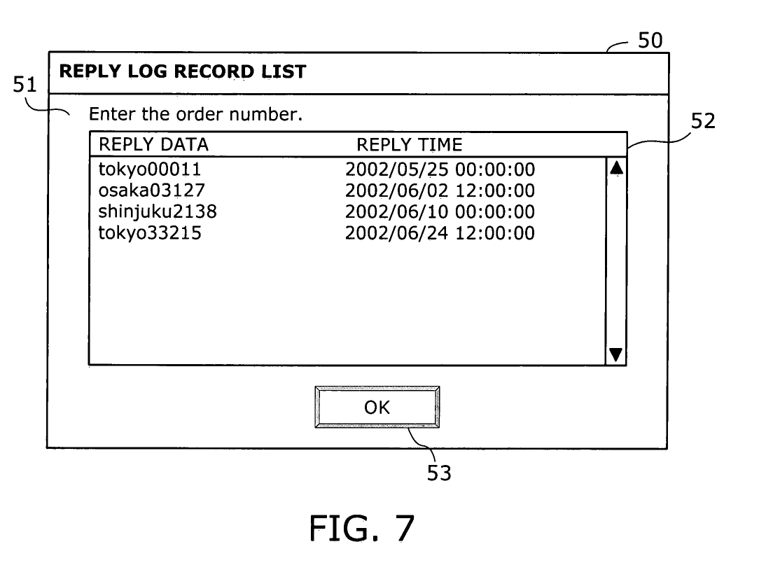

FIG. 7 shows an example of the reply log listing screen mentioned above. This reply log listing screen 50 contains the following data objects: a message text line 51, a reply log listing area 52, and a command button 53. The message text line 51 shows the message text of a message log record that the operator has selected in the log listing screen 40 of FIG. 6. The reply log listing area 52 is where the operator can view the retrieved reply log records (i.e., replies to past inquiries having the same message text as the selected one). Each reply log record shown in this field 52 consists of reply data and reply date. The command button 53 labeled “OK” is to be pressed by the operator when he/she has finished viewing the records. Pressing this OK button 53 closes the reply log listing screen 50.

From the above-described reply log listing screen 50, the operator can learn what replies were made in the past, when there is a specific inquiry that he/she should answer. Such records of past replies help the operator determine how to answer the inquiry at hand. In the next section, we will explain a series of process steps from issuance of an inquiry API call to displaying of log records.

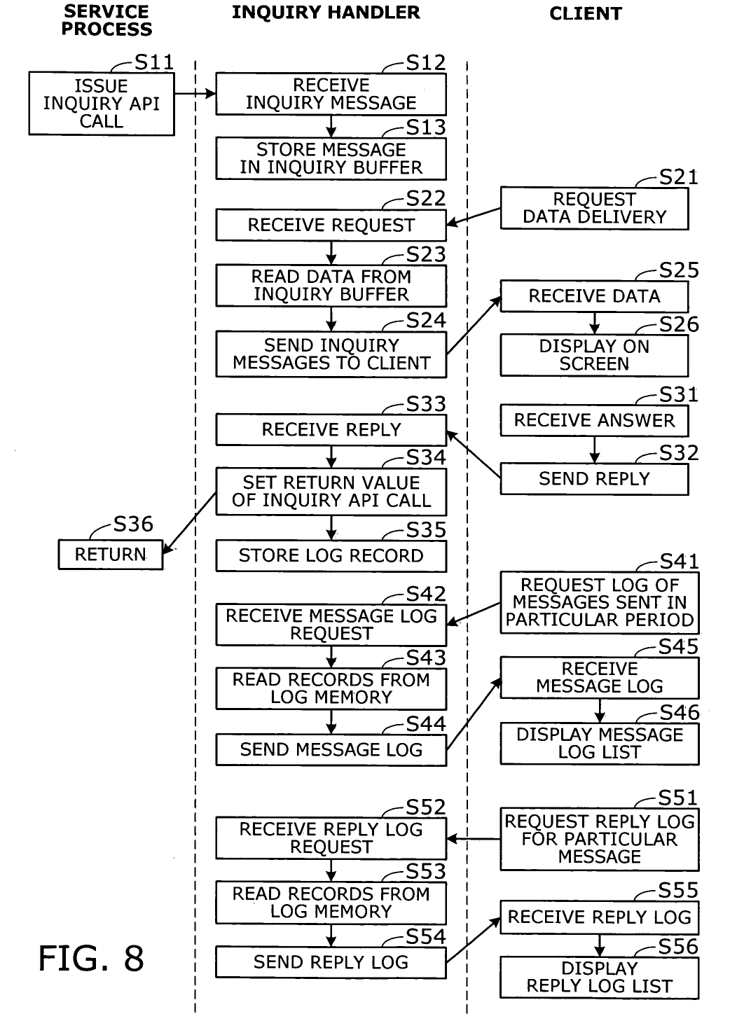

FIG. 8 is a sequence diagram which shows a process of displaying log records. FIG. 8 depicts this process as a series of interactions between the following three groups of entities: service process 110, inquiry handler 120, and clients 210 and 220. The process of FIG. 8 includes the following steps:

(S11) The service process 110 issues an inquiry API call.

(S12) The inquiry receiver 121 receives an inquiry message produced by the inquiry API call.

(S13) The inquiry receiver 121 stores message data in the inquiry buffer 122.

The above operation of recording inquiry data takes place each time the service process 110 invokes a new inquiry API call, and a plurality of inquiry records accumulate in the inquiry buffer 122 over time. Later, those pending inquiries is transmitted upon request from the client 210 according to the following procedure.

(S21) In response to console input from the operator, the reply entry manager 211 in the client 210 requests the inquiry message sender 123 in the server 100 to deliver the inquiry data.

(S22) The inquiry message sender 123, which has been waiting for a request from clients, now receives a delivery request from the reply entry manager 211 in the client 210.

(S23) The inquiry message sender 123 reads out inquiry data from the inquiry buffer 122.

(S24) The inquiry message sender 123 produces an inquiry message from the inquiry data read out at step S23 and sends a collection of inquiry messages to the reply entry manager 211 in the requesting client 210.

(S25) The reply entry manager 211 receives the inquiry messages from the inquiry message sender 123.

(S26) The reply entry manager 211 displays the list of inquiry messages, and then enters the state of waiting for console input from the operator.

(S31) The reply entry manager 211 receives an answer from the operator.

(S32) The entry of an answer permits the reply entry manager 211 to send a reply message back to the reply message receiver 124 in the server 100.

(S33) The reply message receiver 124 in the server 100 receives the reply from the reply entry manager 211 in the client 210.

(S34) The reply message receiver 124 outputs the received reply as a return value of the inquiry API call initiated by the service process 110.

(S35) The reply message receiver 124 associates the received reply with its corresponding original inquiry and stores them in the log memory 300 as log records. Each such record contains a message log record and a reply log record.

(S36) The service process 110 receives the reply, or the return value of the inquiry API call, and resumes the service task that has been suspended since the issuance of the inquiry API call.

The above steps delivers a reply from the operator to the requesting service process 110 and permits the service process 110 to resume its pending task according to the operator's instruction. Log records of such interactions are accumulated in the log memory 300, which can be referenced by the operator at any time when he/she need them. The following is a process that permits the operator to consult message log records.

(S41) In response to console input from the operator, the log display processor 221 in the second client 220 requests the message log sender 125 in the server 100 to send message log records. This request may include some search criteria to narrow down the range of message log records to be extracted for reference purposes. The operator may specify, for example, a particular reception period of reply so as to obtain a collection of message log records about the inquiries that were answered during the specified period.

(S42) The message log sender 125 in the server 100 receives the message log request.

(S43) The message log sender 125 searches the log memory 300 to find log records that match with the search criteria specified in the given message log request. If such log records are found, the message log sender 125 retrieves their respective message log records from the log memory 300.

(S44) The message log sender 125 sends the retrieved message log records to the log display processor 221 in the client 220.

(S45) The log display processor 221 in the client 220 receives the message log records.

(S46) The log display processor 221 displays the received message log records in list form.

The above steps provide the operator at the client 220 with the records of past inquiry messages (message log records) for the purpose of reference. Particularly, the operator may be interested in what replies were made to those past inquiry messages. The following is a process that permits him/her to browse such information (reply log records).

(S51) In response to console input from the operator, the log display processor 221 in the client 220 requests the reply log sender 126 in the server 100 to send reply log records relevant to a particular message log record.

(S52) The reply log sender 126 in the server 100 receives the reply log request.

(S53) The reply log sender 126 searches the log memory 300 to find such reply log records that fit the message log record specified in the message log request.

(S54) The reply log sender 126 sends the retrieved reply log records to the log display processor 221 in the requesting client 220.

(S55) The log display processor 221 in the client 220 receives reply log records.

(S56) The log display processor 221 displays the received reply log records in list form.

The above steps permits: the operator to view the records of past replies made to an inquiry.

What we have described so far is the basic operation of the present embodiment. The present embodiment has various additional functions to help the operator to enter a reply. The following sections will explain those additional functions of the present embodiment in detail.

### Multiple-choice Selection

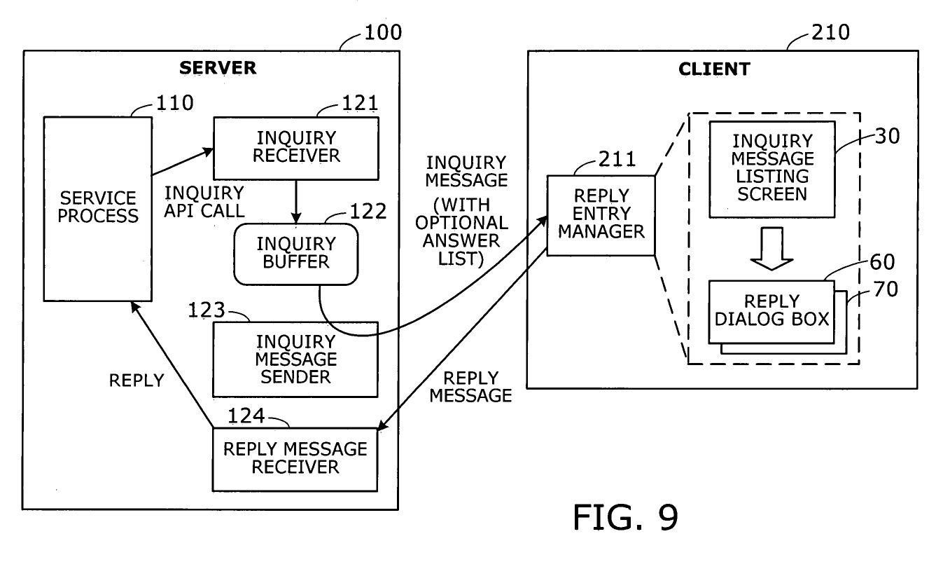

In the present embodiment, the reply entry manager 211 in the first client 210 gives the operator a list of possible answers to a given inquiry message, thus allowing him/her to make a reply by selecting one of them. FIG. 9 explains the concept of how the operator will do this. When the service process 110 needs an instruction from the operator, it invokes an inquiry API call with parameters including: message text, a reply method identifier, and a list of possible answers (or answer list). The message text is a character string that explains what and how the operator is supposed to answer. The reply method identifier is actually a flag that indicates whether a reply is made either by selecting one of possible answers (multiple choice) or by entering a text string (free text input). An answer list gives a collection of data that can be a reply to the present inquiry. This list is included as part of inquiry parameters only when “reply with selection” is specified.

When an inquiry is produced as a result of an inquiry API call from the service process 110, the inquiry receiver 121 stores a record of that inquiry in the inquiry buffer 122. This record includes message text, a reply method identifier, and an answer list.

The reply entry manager 211 running on the client 210 sends a message delivery request to the inquiry message sender 123 over the network. In response to this, the inquiry message sender 123 searches the inquiry buffer 122 to retrieve a relevant set of message text, reply method identifier, and answer list stored in the inquiry buffer 122. The inquiry message sender 123 compiles an inquiry message from the obtained data and sends it to the client 210 over the network.

In the client 210, the reply entry manager 211 receives inquiry messages from the inquiry message sender 123, and it produces an inquiry message listing screen 30 for display. This screen 30 allows the operator to select a desired inquiry message and gives a command to the client 210 (e.g., pressing “REPLY” command button 31e) to initiate a prescribed reply sequence. The reply entry manager 211 then examines the reply method identifier of the selected message, thus determining in what method the operator should answer. When the selected inquiry is a multiple-choice type question (i.e., the respondent is to choose one of possible answers given in the inquiry), the reply entry manager 211 produces a reply dialog box 60 containing a list of selectable answers. When, the selected inquiry is a text type question, the reply entry manager 211 produces another type of reply dialog box 70 containing a text box for the operator to enter reply data.

When a multiple-choice type reply dialog box 60 appears on the screen, the operator chooses an appropriate answer from among those shown in the answer list. When it is a free-text type reply dialog box 70, which contains a text box for data entry, the operator fills in the text box using the keyboard. With the input given by the operator in the reply dialog box 60 or 70, the reply entry manager 211 delivers reply data to the server 100 by sending a reply message. In the server 100, the reply message receiver 124 receives the reply message, and it forwards the reply to the requesting service process 110.

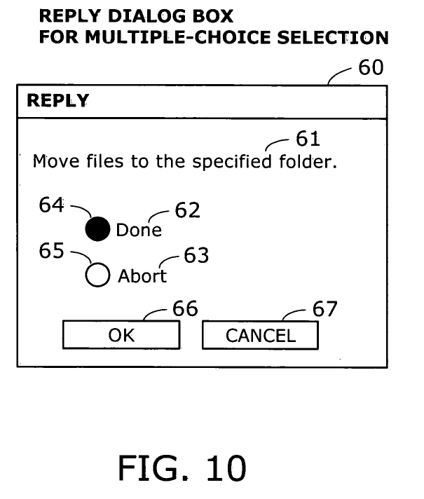

FIG. 10 shows an example of the reply dialog box 60 mentioned above. This reply dialog box 60 is composed of a message text line 61 showing the selected inquiry message, possible answers 62 and 63, check boxes 64 and 65 for respective answers, and command buttons 66 and 67.

In the example of FIG. 10, the message text 61 reads “Move files to the specified folder.” This is followed by two possible answers 62 and 63, which read “Done” and “Abort,” respectively. Attached to those answers 62 and 63 are check boxes 64 and 65, respectively. The operator selects the first check box 64 when his/her reply is: “Done,” or the second check box 65 when he/she wishes to “Abort.” The operator is allowed to choose either the first check box 64 or the second check box 65 exclusively. In other words, selecting one check box will cause the other check box to become deselected automatically.

The left command button 66 labeled “OK” allows the current reply data to take effect. That is, when this OK button 66 is pressed, the reply entry manager 211 produces a reply message containing the selected answer and sends it back to the server 100 over the network. The right command button 67 labeled “CANCEL,” on the other hand, is used to cancel the entry of an answer. Pressing the command button 67 closes the reply dialog box 60 without transmitting a reply.

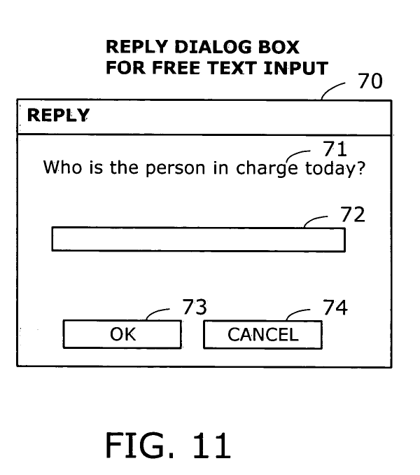

FIG. 11 shows an example of a reply dialog for free-text type inquiries. This reply dialog box 70 is composed of the following elements: a message text line 71 showing the selected inquiry message, a text box 72, and command buttons 73 and 74.

In the example of FIG. 11, the message text 71 reads “Who is the person in charge today?” The text box 72 is the field where the operator enters his/her answer. The operator uses a keyboard or other input devices to fill in the text box 72 with character strings as his/her answer to the given inquiry.

The left command button 73 labeled “OK” allows the current reply data to take effect. That is, when this OK button 73 is pressed, the reply entry manager 211 produces a reply message containing the answer in the text box 72 and sends it back to the server 100 over the network. The right command button 74 labeled “CANCEL,” on the other hand, is used to cancel the: entry of an answer. Pressing this command button 74 closes the reply dialog box 70 without transmitting a reply.

The next section will now describe the processing steps that deal with a multiple-choice type inquiry.

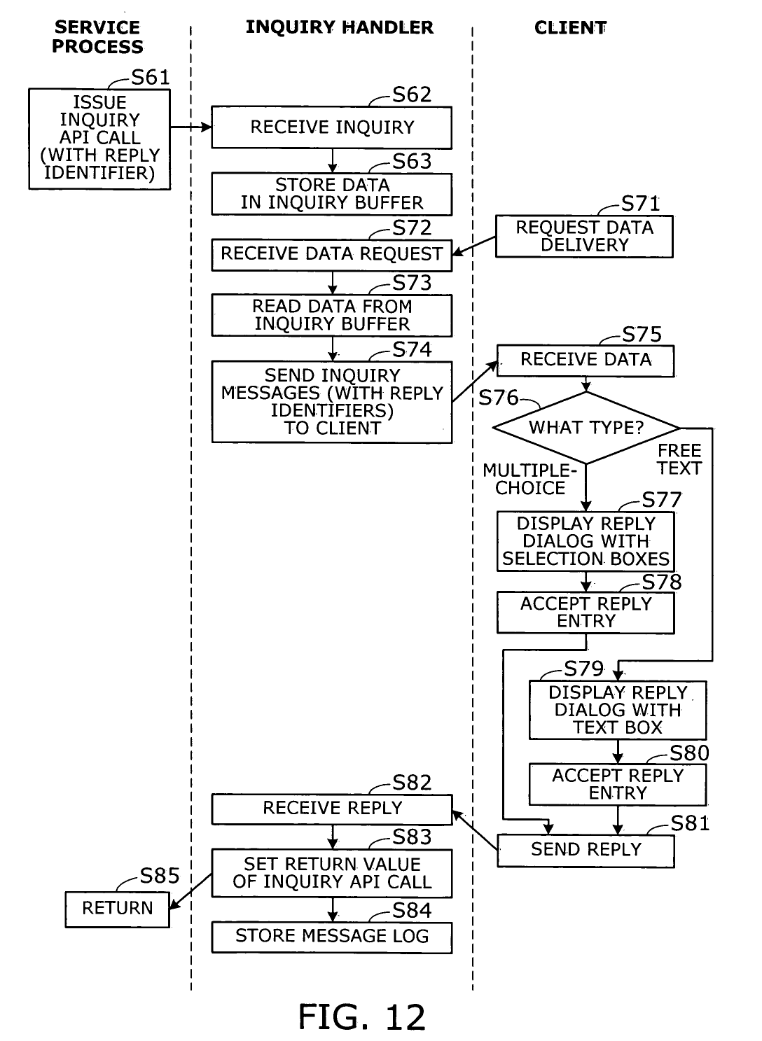

FIG. 12 is a sequence diagram which includes a process of multiple-choice selection. The process is visualized as a series of interactions between the following three groups of processing entities: service process 110, inquiry handler 120, and clients 210 and 220. The process of FIG. 12 includes the following steps.

(S61) The service process 110 issues an inquiry API call. Parameters of this inquiry API call include a reply method identifier and an answer list. For example, the reply method identifier may specify “multiple-choice type,” and it is accompanied by two possible answers, “Done” and “Abort,” to the question.

(S62) The inquiry receiver 121 receives an inquiry message produced by the inquiry API call.

(S63) The inquiry receiver 121 records the received inquiry in the inquiry buffer 122.

The inquiry is delivered afterwards to the client 210 upon request, as will be described in the following steps S71 to S74.

(S71) In response to console input from the operator, the reply entry manager 211 in the client 210 requests the inquiry message sender 123 in the server 100 to deliver pending inquiries.

(S72) The inquiry message sender 123 in the server 100 has been waiting for data delivery request from clients. It now receives the data request that the reply entry manager 211 in the client 210 issued at step S71.

(S73) The inquiry message sender 123 reads out inquiry data from the inquiry buffer 122.

(S74) The inquiry message sender 123 compiles an inquiry message containing each inquiry read out of the inquiry buffer 122 and sends them to the reply entry manager 211 in the client 210. An inquiry message contains a message text string and a reply method identifier. In the case the reply method identifier indicates that the question is of multiple-choice type, the message further carries a list of possible answers.

(S75) The reply entry manager 211 in the client 210 receives inquiry messages from the inquiry message sender 123.

(S76) The reply entry manager 211 examines the reply method identifier of each message. If the reply method identifier indicates multiple-choice selection, the process advances to step S77. If it indicates free text entry, the process advances to step S79.

(S77) The reply entry manager 211 displays a reply dialog box that contains a list of selectable answers.

(S78) The reply entry manager 211 receives an input indicating which answer the operator has selected from among those shown in the dialog box. The process then proceeds to step S81.

(S79) The reply entry manager 211 displays a reply dialog box for free text entry.

(S80) The reply entry manager 211 receives an answer that the operator has entered to the text box in the reply dialog box.

(S81) The reply entry manager 211 sends the received answer to the reply message receiver 124 in the server 100 as a reply to the inquiry of interest.

(S82) The reply message receiver 124 in the server 100 receives the reply from reply entry manager 211 in the client 210.

(S83) The reply message receiver 124 outputs the received reply as the return value of the inquiry API call initiated by the service process 110.

(S84) The reply message receiver 124 associates the received reply with its corresponding original inquiry and stores both of them (i.e., a message log record and a reply log record) in the log memory 300 as a new log record entry.

(S85) The service process 110 receives the reply, or the return value of the inquiry API call, and resumes the task that has been suspended since the issuance of the inquiry API call.

Through the above steps, the operator can answer an inquiry by selecting an appropriate item from a list of given possible answers when the inquiry's reply method identifier indicates the use of a multiple-choice selection method.

### Browsing Reply Log Records

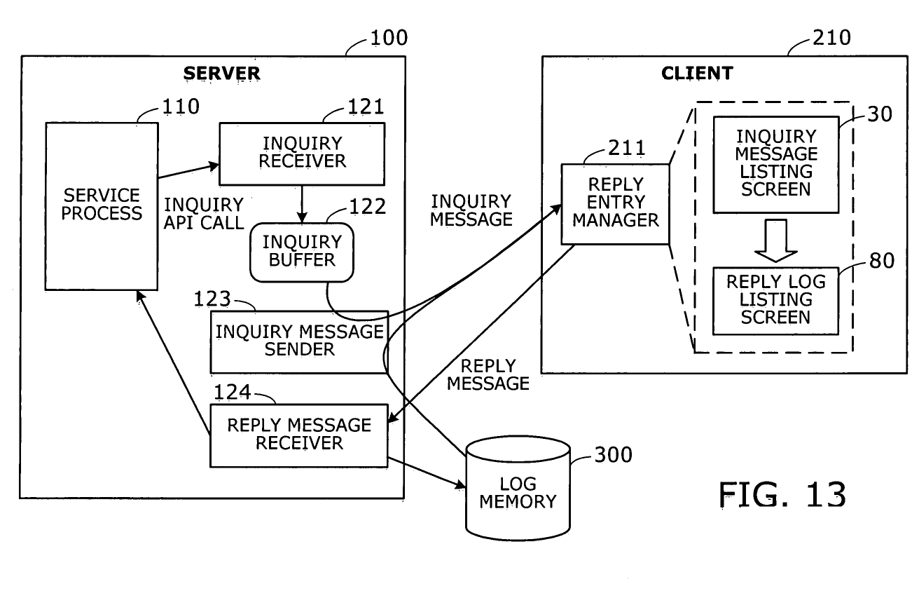

This section describes a process executed by a client 210 in order to allow the respondent to consult the records of past replies when he/she makes a reply. FIG. 13 is a conceptual view of such an answer selection process. The illustrated process is initiated by the service process 110 in the server 100, which issues an inquiry API call when it needs some instructions from the operator. In response to the inquiry API call, the inquiry receiver 121 produces a new entry for the inquiry buffer 122 to store the content of the inquiry. The reply entry manager 211 running on the client 210 sends a message delivery request to the server 100 over the network. This causes the inquiry message sender 123 in the server 100 to retrieve pending inquiries from the inquiry buffer 122. The inquiry message sender 123 also searches the log memory 300 in an attempt to find reply log records that match with each pending inquiry in terms of, for example, thee similarity of message text. The inquiry message sender 123 then compiles inquiry messages from the records retrieved from the inquiry buffer 122 and log memory 300 and sends them to the client 210 over the network.

In thee client 210, the reply entry manager 211 receives the inquiry messages sent from the inquiry message sender 123, and it produces an inquiry message listing screen 30 for display. This screen 30 allows the operator to select an inquiry message and commands the client 210 to activate a reply procedure by, for example, pressing the “REPLY” command button 31e. When there are reply log records relevant to the selected inquiry message, the reply entry manager 211 outputs a reply dialog box containing a list of reply log records (e.g., reply dialog box 80 with a past reply list described later). The operator may find an appropriate item in the list of reply log records displayed on the screen. If this is the case, the operator selects that record as an answer. Or if this is not the case, including when there are no relevant log records, the operator can type in the answer in the dialog box.

The reply entry manager 211 sends a reply message to the reply message receiver 124 over the network. Upon receipt of the reply, the reply message receiver 124 hands it over to the service process 110, and at the same time, it saves a log record in the log memory 300, which includes: message text, reply data, reply date, and other related items.

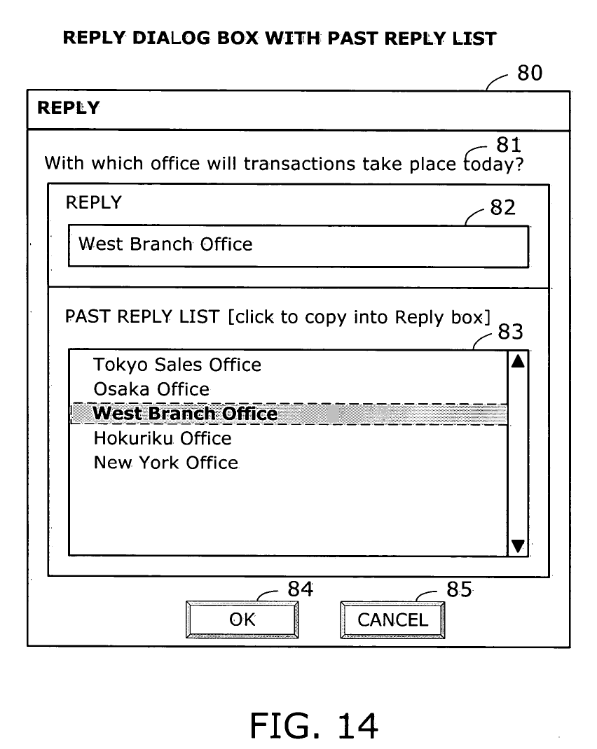

FIG. 14 shows an example of a reply dialog box with a list of past replies. The illustrated reply dialog box 80 has the following elements: a message text line 81 shown in the inquiry of interest, a text box 82 for entering an answer, a reply log field 83, and two command buttons 84 and 85. In this example of FIG. 14, the message text 81 reads “With which office will transactions take place today?” The text box 82 is used by the operator to enter his/her answer. The reply log field 83 shows a list of reply log records, i.e., the records of replies that were made to past inquiry messages with the same content as the ones that the operator has chosen. When the operator selects one of those reply log records, the selected record is copied into the text box 82. For example, FIG. 14 shows a situation where the operator has selected “West Branch Office” from the list.

The left command button 84 labeled “OK” is pressed by the operator when he/she wishes the current content of the text box 82 to be sent out as the answer. Pressing this OK button 84 permits the reply entry manager 211 to take in the content of the text box 82 and transmit it as a reply message to the reply message receiver 124 in the server 100. Thee right command button 85 labeled “CANCEL” is used to cancel the entry of an answer. Pressing this command button 85 closes the reply dialog box 80 without transmitting a reply.

The operator can reuse the records of past replies to answer a given inquiry message in the way described above, with reduced possibilities of making a mistake in entering a text string. This feature of the present embodiment makes the operator's job easy particularly when he/she has to answer similar questions many times.

### Answer List and Reply Log Records

While we have described the use of an answer list and a reply log list as separate reply methods, it is possible to combine those two methods. In this case, the service process 110 gives a reply method identifier to each inquiry API call as an additional parameter. When the reply method identifier indicates that a multiple-choice selection should be made, an answer list will be given as an additional parameter of an inquiry API call. Such data of each inquiry is saved in the inquiry buffer 122.

When a message delivery request is received from the reply entry manager 211, the inquiry message sender 123 searches the inquiry buffer 122 to retrieve pending inquiries, including their message text, answer lists, and reply method identifiers. The inquiry message sender 123 further searches the log memory 300 to find log records relevant to each pending inquiry. Messages addressed to the reply entry manager 211 include all those data items obtained from the inquiry buffer 122 and log memory 300.

Upon receipt of an inquiry messages, the reply entry manager 211 first examines its reply method identifier to determines what reply method is specified. When the inquiry turns out to be a multiple-choice type question, the reply entry manager 211 produces a reply dialog box containing an answer list. The operator can choose an appropriate answer from among the possible answers displayed on the monitor screen. When, on the other hand, the inquiry is a text type question, the reply entry manager 211 produces a reply dialog box with a text box to allow the operator to enter an answer. Further, if there are relevant reply log records, the reply entry manager 211 includes those records in the reply dialog box, thus allowing the operator to choose one of the past answers if he/she finds it appropriate. The reply entry manager 211 sends the selected answer to the reply message receiver 124 in the server 100 as a reply to the inquiry.

### Handling Reply Timeouts

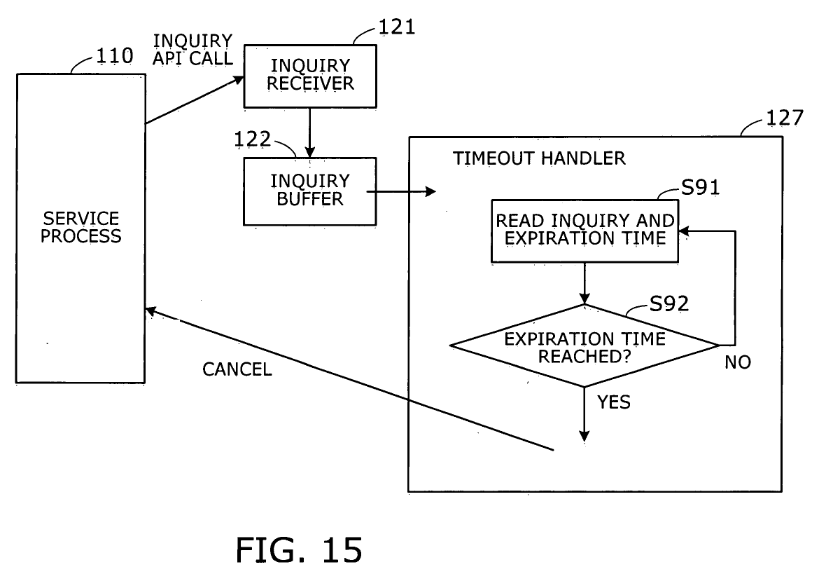

This section describes timeout processing for inquiries pending in the inquiry buffer 122. FIG. 15 is a functional block diagram of a server with timeout processing functions. While the illustrated server 100 actually has various functions, FIG. 15 shows a limited number of elements that are related to timeout processing, which are: a service process 110, an inquiry receiver 121, an inquiry buffer 122, and a timeout handler 127. Timeout processing is achieved through the cooperation between these elements.

The service process 110 issues an inquiry API call when it needs instructions from the operator. The inquiry API call from the service process 110 produces an inquiry, and the inquiry receiver 121 saves this inquiry in the inquiry buffer 122. The role of the timeout handler 127 is, in short, to check the expiration of a predefined timeout period for each pending inquiry in the inquiry buffer 122 and notify the service process 110 of the timeout event when it happens. More specifically, this timeout detection process follows the steps described below.

When it needs instructions from the operator, the service process 110 issues an inquiry API call to the operator, with a piece of message text as one of its parameters. The issuance of such an inquiry API call causes the inquiry receiver 121 to produce a new entry for the inquiry buffer 122, which contains inquiry data (e.g., message text) and expiration time in an associated manner. Here, the expiration time is calculated by adding a predetermined timeout period to the issuance time of the inquiry API call.

The timeout handler 127 makes access to the inquiry buffer 122 at regular intervals to read out each set of inquiry data and expiration time (step S91). The timeout handler 127 then checks the status of every pending inquiry and determines whether their expiration times have been reached (step S92). If the expiration time of a particular inquiry has been reached, the timeout handler 127 recognizes it as a timeout of that inquiry. The timeout handler 127 then returns a cancel code to the requesting service process 110, indicating that the pending inquiry has been expired. Non-expired inquiries remain in the inquiry buffer 122 and are subjected to the next timeout checking task after a predetermined cycle period.

The aforementioned timeout period may be specified as a startup parameter or defined in an initialization file (e.g., INI file). Expiration times may be calculated, not beforehand, but at the time each pending inquiry is tested. In this case, the inquiries are stored in the inquiry buffer 122, together with their respective issuance times.

### Timeout Period specified by Service Processes

The timeout period of each inquiry may also be specified by the requesting service process 110 when it issues an inquiry API call. In this case, the service process 110 gives a timeout period value as one of the parameters of each inquiry API call that it issues. Upon issuance of such an inquiry API call, the inquiry receiver 121 produces a new entry for the inquiry buffer 122, which, contains inquiry data (e.g., message text), and the corresponding expiration time parameter. Expiration time of each inquiry is calculated by adding the specified timeout period to the issuance time of the inquiry API call. Instead of storing calculated expiration times in the inquiry buffer 122, the inquiry receiver 121 may save their original API call issuance times and specified timeout periods, together with the corresponding inquiry data.

The timeout handler 127 makes access to the inquiry buffer 122 at regular intervals in order to read out each set of inquiry data and expiration time (step S91). The timeout handler 127 then checks the status of every pending inquiry and determines whether its expiration time has been reached (step S92). If the expiration time of a particular inquiry has been reached, the timeout handler 127 recognizes it as a timeout of that inquiry. The timeout handler 127 then returns a cancel code to the requesting service process 110, indicating that the pending inquiry has been expired.

While there is only one service process in the example of FIG. 15, the real-world system may have a plurality of such processes. Therefore, the method described in this section makes it easy for the individual service processes to specify timeout periods of pending inquiries independently of each other.

### Timeout Period Identifiers

Inquiry API calls produced by the service process 110 may have a timeout period identifier as one of its parameters, so that the timeout handler 127 can determine the length of timeout period from that timeout period identifier. To this end, a timeout period table has to be created previously for use by the timeout handler 127.

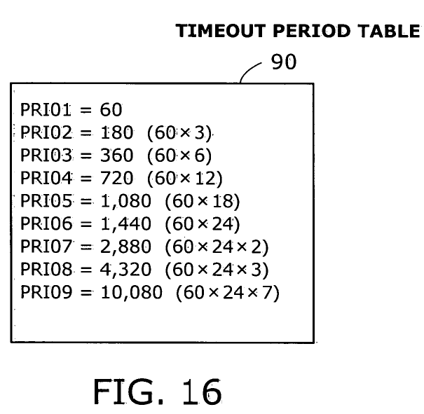

FIG. 16 shows an example of a timeout period table. The illustrated timeout period table 90 defines multiple sets of a timeout period identifier and its corresponding time length. More specifically, this table 90 contains ten entries of timeout periods identifiers “PRI01” to “PRI09,” each of which is assigned a specific timeout period in units of minutes. The text in the parentheses suggests the time length in units of hours or days or weeks. In the example of FIG. 16, timeout period “PRI01” is set to 60 minutes (one hour). Timeout period “PRI02” is set to 180 minutes (three hours). Timeout period “PRI03” is set to 360 minutes. (six hours). Timeout period “PRI04” is set to 720 minutes (twelve hours). Timeout period, “PRI05” is set to 1,080 minutes (eighteen hours). Timeout period “PRI06” is set to 1,440 minutes (one day). Timeout period “PRI07” is set to 2880 minutes (two days). Timeout period “PRI08” is set to 4,320 minutes (three days). Timeout period “PRI09” is set to 10,080 minutes (one week).

As can be seen from the above example of the timeout period table 90, a different timeout value is assigned to each different timeout period identifier. In the server 100, the timeout period table 90 may be defined as part of a system configuration file (e.g., INI file) or entered through a graphical user interface (GUI) for configuration setup.

Suppose, for example, that the service process 110 needs an instruction from the operator. Then it invokes an inquiry API call including a piece of message text and an appropriate timeout period identifier as parameters. This inquiry API call causes the inquiry receiver 121 to consult the timeout period table 90 to read out the value of timeout period corresponding to the specified timeout period identifier. The inquiry receiver 121 then adds the obtained timeout period to the issuance time of the ongoing inquiry API call, thereby calculating an expiration time. This expiration time is entered to the inquiry buffer 122, together with other data related to the inquiry.

The timeout handler 127 makes access to the inquiry buffer 122 at regular intervals to examine the expiration of each pending inquiry, and if the expiration time of a particular inquiry has been reached, the timeout handler 127 recognizes that inquiry message as an expired message. The requesting server program module thus receives a cancel code indicating that the pending inquiry should be canceled due to timeout.

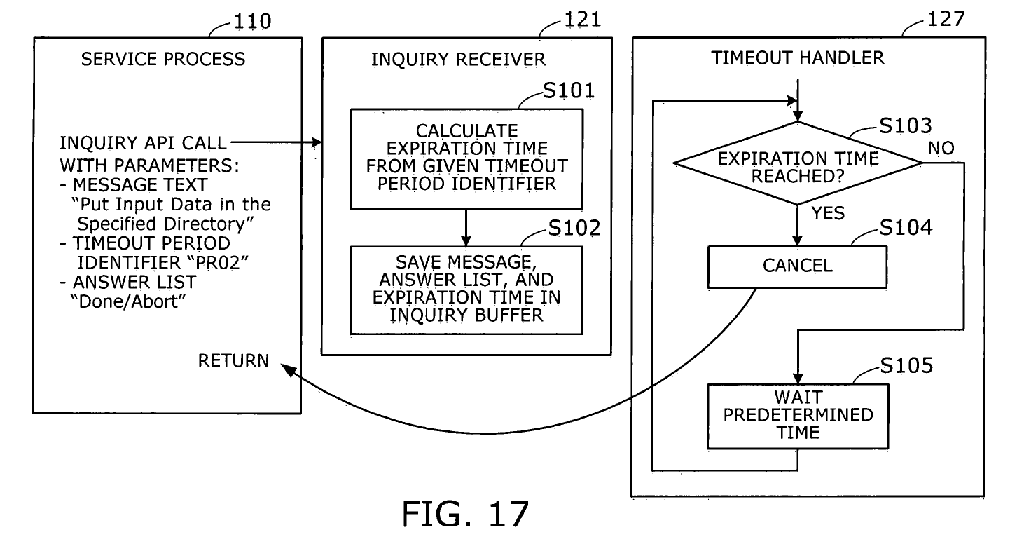

FIG. 17 shows an example of timeout processing using a timeout period table in such a situation where no response has been returned from the operator before the expiration time is reached.

In response to some console input from the operator, the inquiry receiver 121 enters sets of timeout period identifiers and corresponding timeout periods. When it needs instructions from the operator, the service process 110 issues an inquiry API call with a timeout period identifier attached as a parameter. The parameters of this inquiry API call include, for example, the following items: message text “Put Input Data in the Specified Directory,” an answer list “Done/Abort,” and a timeout period identifier “PRI02.”

As previously mentioned, the timeout period for identifier “PRI02” is three hours. The inquiry receiver 121 adds this three hours to the current time of day, thereby calculating the expiration time of the ongoing inquiry API call (step S101). After that, the inquiry receiver 121 saves the new inquiry in the inquiry buffer 122 (step S102), including the message text, possible answers, and expiration time. Note that this may not necessarily beg the sole content of the inquiry buffer 122. Rather, the inquiry buffer 122 may have accumulated like inquiries produced by other service processes.

The timeout handler 127 checks the expiration time of each pending inquiry (step S103). If the expiration time of a particular inquiry is reached, the timeout handler 127 returns a cancel code to the requesting service process 110, indicating that the pending inquiry has been expired (step S104). This allows the server program to resume execution, taking a path to its cancel routine. For other non-expired inquiries (step S105), the timeout handler 127 waits for a predetermined period (e.g., one minute) and then goes back to step S103 to check the expiration times again.

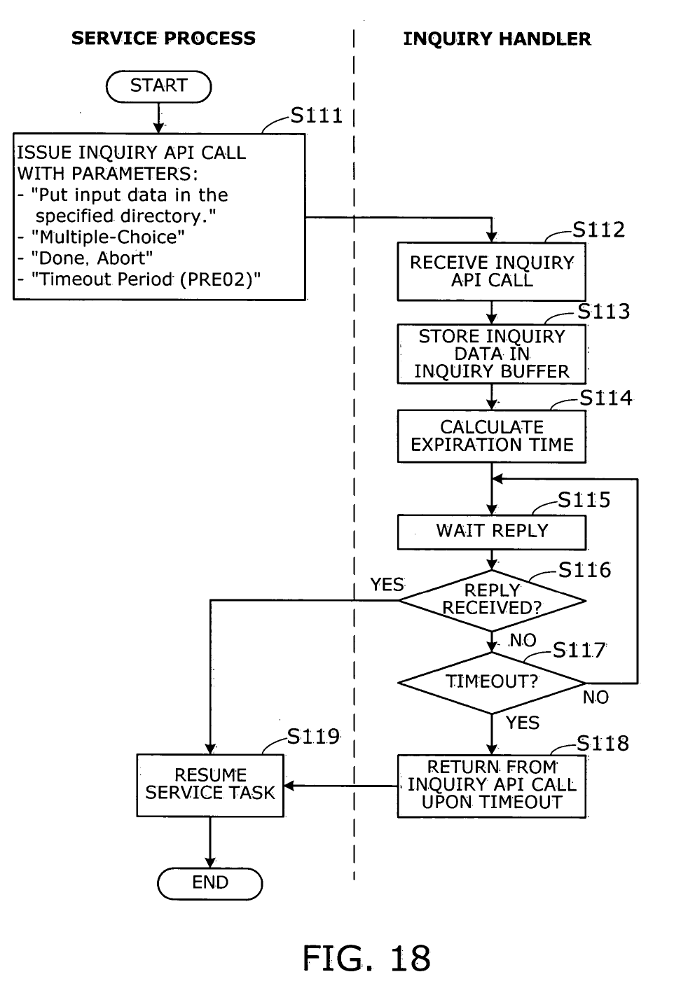

FIG. 18 is a sequence diagram showing a procedure of timeout processing. FIG. 18 depicts this process as a series of interactions between the service process 110 and inquiry handler 120.

The service process 110 issues an inquiry API call when it needs an instruction from the operator (step S111). This inquiry API call has the following parameters: message text “Put input data in the specified directory”; a reply method identifier “Multiple-Choice”; an answer list “Done/Abort,”; and timeout period identifier “PRE02” (or a specific timeout value). The service process 110 then puts itself into a wait state and stays there until the API returns control to the caller.

The inquiry API call invoked at step S111 is directed to the inquiry receiver 121 in the inquiry handler 120 (step S112). The inquiry receiver 121 saves the received inquiry data in the inquiry buffer 122 (step S113). Subsequently the inquiry receiver 121 consults the timeout period table to obtain the value of timeout period corresponding to the specified timeout period identifier. The inquiry receiver 121 calculates an expiration time by adding the timeout period to the present time of day (step S114). The calculated expiration time is then stored in the inquiry buffer 122, together with other data about the inquiry.

The reply message receiver 124 waits a reply from the reply entry manager 211 in the client 210 (step S115), while watching the time elapsed since the API call. When there is a reply message from the operator (“YES” at step S116), the reply message receiver 124 forwards it to the service process 110. Then the service process 110 uses the result of the inquiry as setup parameters or the like and returns to its original service task (step S119). When, on the other hand, a predetermined period (e.g., one minute) has passed without receiving a reply (“NO” at step S116), the timeout handler 127 compares the expiration time of the pending inquiry with the present time of day (step S117). If the expiration time is not reached (“NO” at step S117), the timeout handler 127 goes back to step S115 for another round. If the expiration time has been reached (“YES at step S117), the timeout handler 127 returns control to the caller of the inquiry API call (step S118). The caller, or the service process 110, accepts the timeout (or cancellation) of its inquiry and thus resumes the original services task accordingly (step S119).

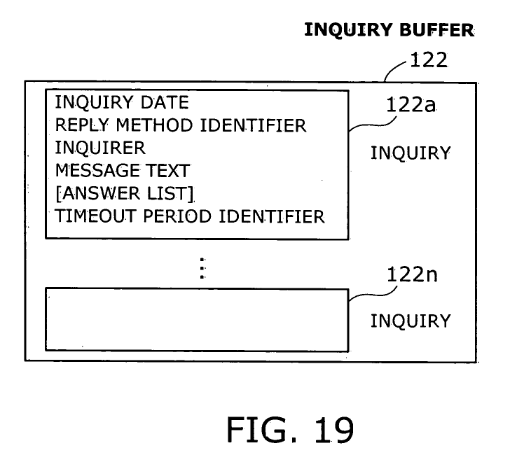

For timeout processing, the inquiry buffer 122 and log memory 300 are structured as follows. FIG. 19 shows an example of data structure of the inquiry buffer 122. As can be seen from this drawing, the inquiry buffer 122 stores a plurality of inquiry records 122a to 122n, each produced by a newly issued inquiry API call. Each inquiry record 122a to 122n contains the following correlated data items: inquiry date, reply method identifier, inquirer, message text, answer list, and timeout period identifier. The inquiry date field shows when the inquiry API call was issued by a service process 110. The reply method identifier indicates which reply method to use (e.g., multiple-choice selection or free text entry). The inquirer filed contains a code for identifying which service process 110 has invoked the inquiry API call. The message text field shows the text of a message addressed to the operator. The answer list is an optional field that contains possible answers to the inquiry, which is included only when a multiple-choice method is specified. The timeout period identifier specifies the length of timeout period.

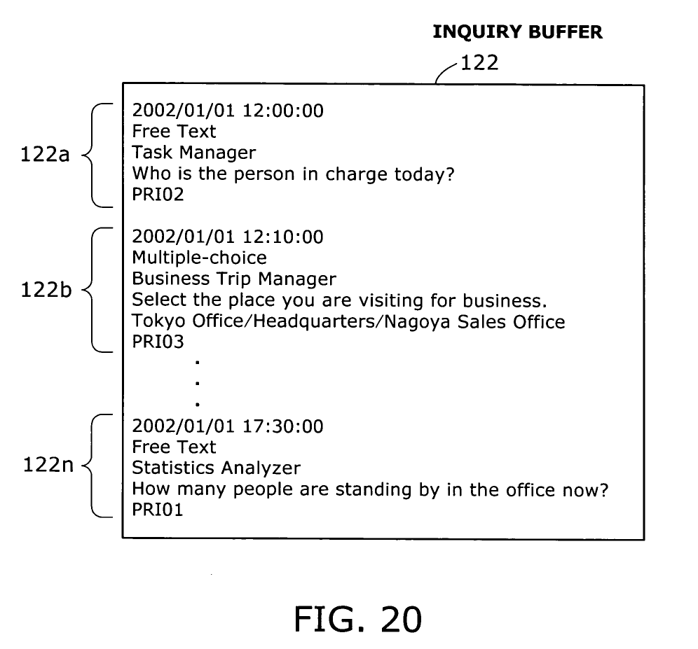

FIG. 20 shows a specific example of data stored in the inquiry buffer 122. In this example, the topmost entry 122a represents an inquiry with the following properties:

inquiry date=“2002/01/01 12:00:00”.

reply method identifier=“Free Text”

inquirer=“Task Manager”

message text=“Who is the person in charge today?”

timeout period identifier=“PRI02.”

The next entry, 122b represents another inquiry with the following properties:

inquiry date=“2002/01/01 12:10:00”

reply method identifier=“Multiple-Choice”

inquirer=“Business Trip Manager”

message text=“Select the place you are visiting for business”

answer list=“Tokyo Office/Headquarters/Nagoya Sales Office”

timeout period identifier=“PRI03”

Likewise, the bottommost entry 122n represents yet another inquiry with the following properties:

inquiry date=“2002/01/01 17:30:00”

reply method identifier=“Free Text”

inquirer=“Statistics Analyzer”

message text=“How many people are standing by in the office now?”

timeout period identifier=“PRI01”

As can be seen from the above example, the present embodiment uses a timeout period table for management of each inquiry's timeout period. This feature enables timeout periods to be changed without affecting the design of the service process 110.

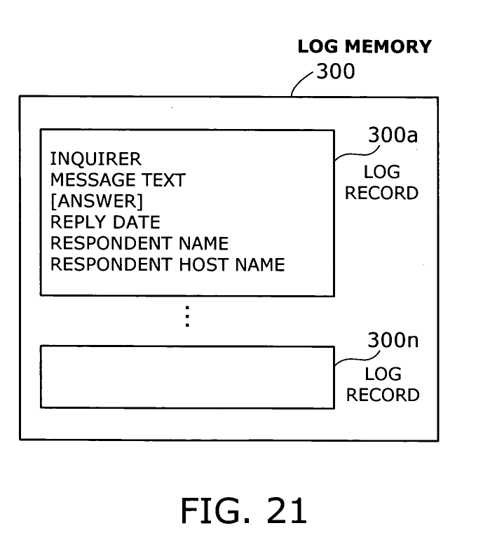

FIG. 21 shows an example of data structure of the log memory 300. As can be seen from this diagram, the log memory 300 stores a plurality of log records 300a to 300n, each produced when a reply is returned or a timeout event occurs. Each log record 300a to 300n contains the following data field: inquirer, message text, answer, reply date, respondent name, and replying host name. The inquirer filed contains a code for identifying which service process 110 originated the inquiry API call. The message text field shows the text of a message that was presented to the operator. The answer field shows the result of the inquiry, which was received from the reply entry manager 211. The reply date field indicates when the reply was received from the reply entry manager 211. The respondent name field shows who (or which operator) actually responded to the inquiry. The respondent host name gives a unique identifier of a host that the operator used to send an answer. This information is used to locate the responding client 210.

The above-described data items contained in each log record 300a to 300n are divided into two groups: message log records and reply log records. That is, the inquirer information and message text fall into the message log group, while the answer, reply date, respondent name, and respondent host name fall into the reply log group.

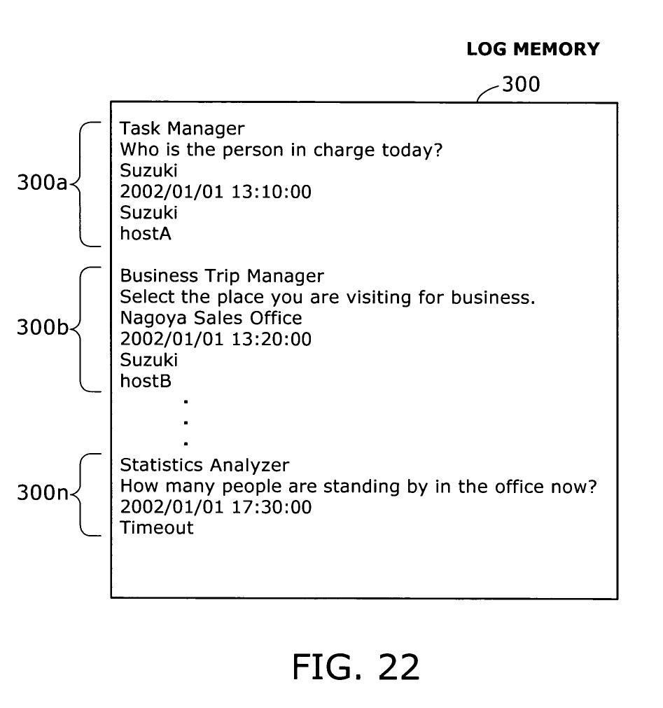

FIG. 22 shows a specific example of data stored in the log memory 300. Specifically, the topmost log record 300a includes the following data items:

inquirer=“Task Manager”

message text=“Who is the person in charge today?”

answer=“Suzuki”

reply date=“2002/01/01 13:10:00”

respondent name=“Suzuki”

respondent host name=“hostA”

The next log record 300b includes the following data items:

inquirer=“Business Trip Manager”

message text=“Select the place you are visiting for business.”

answer=“Nagoya Sales Office”

reply date=“2002/01/01 13:20:00”

respondent name=“Suzuki”

replying host name=“hostB”

The bottommost log record 300n includes the following data items:

inquirer=“Statistics Analyzer”

message text=“How many people are standing by in the office now?”

reply time=“2002/01/01 17:30:00”

answer=“Timeout”

Note that the answer field of this log record 300n is “Timeout,” meaning that the issued inquiry API call ended up with a timeout.

### Supplementary Features of Timeout Handling

(a) Logging expired inquiries

When an inquiry is cancelled due to timeout, the timeout handler 127 records it in the log memory 300 by entering a message log record of the canceled inquiry, as well as a reply log record that indicates the occurrence of the timeout.

(b) Showing inquiry messages with expiration times

In the case an entry of the inquiry buffer 122 has a field value of expiration time, that value may be shown in an inquiry message listing screen as an additional piece of information related to the pending inquiry message. More specifically, the inquiry message sender 123 sends to the reply entry manager 211 an inquiry message containing an expiration time. The reply entry manager 211 displays an inquiry message listing screen, emphasizing inquiry messages whose timeout periods will soon expire. Emphasis on such messages can be achieved by, for example, changing the color of message characters, using a different font, or adding a special icon. This feature helps the operator notice those soon-to-be-expired inquiry messages.

### Executing Command in response to Reply

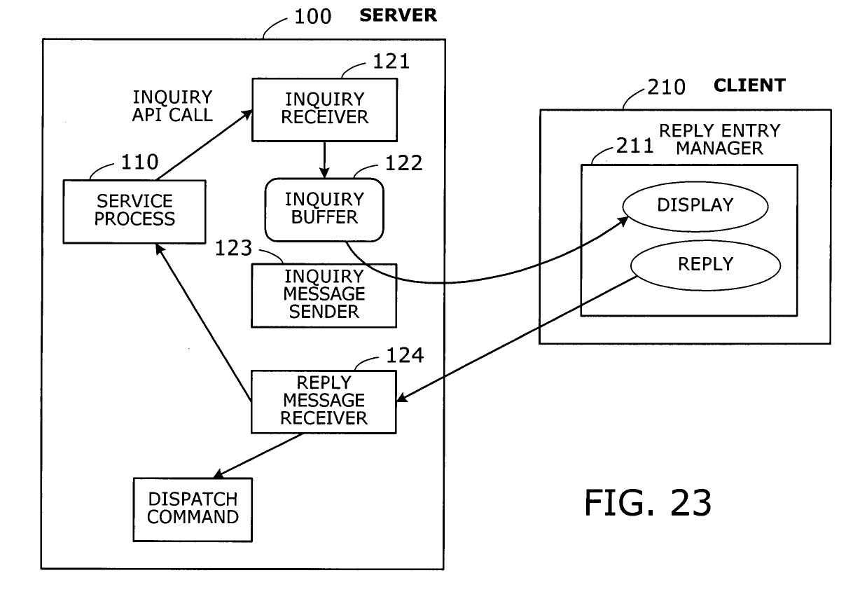

According to the present embodiment of the invention, the server 100 can be configured to execute a predetermined command in response to a reply given by the operator. FIGS. 23 is a conceptual view of a process which executes a command according to a given reply. When it encounters an event that needs an instruction from the operator, the service process 110 invokes an inquiry API call with parameters including a message text string of inquiry and a command line that will be executed when the inquiry is answered. Upon issuance of this inquiry API call, the inquiry receiver 121 stores the message data and command string in the inquiry buffer 122.

The reply entry manager 211 running on a client 210 sends a message delivery request to the inquiry message sender 123 in the server 100 over the network. The inquiry message sender 123 compiles inquiry messages containing inquiries retrieved from the inquiry buffer 122 and sends them to the reply entry manager 211. The reply entry manager 211 produces an inquiry message listing screen accordingly. From among those listed on the screen, the operator chooses one message that he/she is going to respond to and answers that inquiry message. The reply entry manager 211 sends the reply to the reply message receiver 124 over the network. Besides forwarding the received reply to the service process 110, the reply message receiver 124 executes the command string previously specified in the inquiry API call.

Such commands are allowed to reference the content of a reply message as its input parameter. Suppose a situation where the service process 110 needs a piece of input data from the operator before it can execute an instruction “command1,” for example. The service process 110 issues an inquiry API call to accomplish its ongoing task. Parameters of this inquiry API call include, among others, the following data items: message text that reads for example, “Put input data in the specified directory”; an answer list “Done/Abort”; and a command string “command1” that will be dispatched upon receipt of a reply. The inquiry receiver 121 stores an inquiry with those parameters in the inquiry buffer 122.

The operator activates the reply entry manager 211 on the client 210. The reply entry manager 211 receives inquiry messages (containing message text and answer list) from the inquiry message sender 123 over the network and produces an inquiry message listing screen. Those inquiries are based on what have been stored in the inquiry buffer 122. Browsing through the inquiry message listing screen, the operator finds a message that asks him/her to enter input data, whose text line is “Put input data in the specified directory.” The operator thus enters required data in the specified directory. He/she then comes back to the inquiry message listing screen and selects the inquiry message of interest, which causes the reply entry manager 211 to produce a dialog box that prompts him/her to select either “Done” or “Abort.” The operator chooses “Done” in this dialog box. With this answer, the reply entry manager 211 sends a reply message to the reply message receiver 124 over the network, indicating the selection of “Done” as an answer. The reply message receiver 124 returns a reply (“Done”) to the service process 110.

With the above responses, the reply message receiver 124 refers to the relevant record in the inquiry buffer 122 and finds that there is a command to execute. The reply message receiver 124 thus dispatches the command (“command1” in this case) to the operating system of the server 100, attaching a parameter “Done” if so required. This permits the service process 110 not only to resume the pending service task, but also to execute the command “command1” according to the received reply.

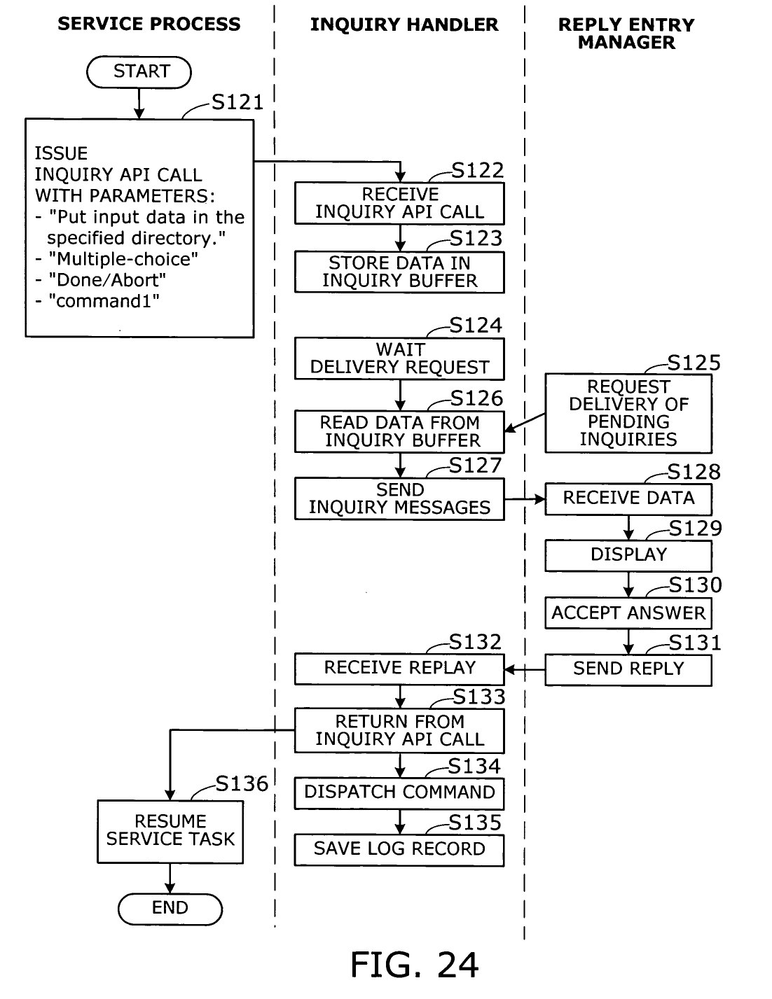

FIG. 24 is a sequence diagram of a process that dispatches a command according to a given reply. FIG. 24 depicts the process as a series of interactions between the following three groups of processing entities: service process 110, inquiry handler 120, and reply entry manager 211.

The service process 110 issues an inquiry API call when it needs an instruction from the operator (step S121). This inquiry API call has the following parameters: message text “Put input data in the specified directory”; a reply method identifier “Multiple-Choice”; an answer list “Done/Abort”; and a command string “command1” to be dispatched. The service process 110 then puts itself into a wait state and stays there until the API returns control to the caller.

The inquiry API call issued at step S121 arrives at the inquiry receiver 121 in the inquiry handler 120 (step S122). The inquiry receiver 121 saves the received data in the inquiry buffer 122 (step S123). The reply message receiver 124 waits for a reply from the reply entry manager 211 in the client 210 (step S124).

In response to console input from the operator, the reply entry manager 211 in the client 210 requests the inquiry message sender 123 in the server 100 to deliver pending inquiries (step S125). The inquiry message sender 123 then retrieves inquiry data from the inquiry buffer 122 (step S126) and sends them as inquiry messages to the requesting reply entry manager 211 (step S127).

The reply entry manager 211 in the client 210 receives inquiry messages sent from the inquiry message sender 123 (step S128) and outputs them on an inquiry message listing screen (step S129). Browsing through the inquiry message listing screen, the operator finds a message with a text line of “Put input data in the specified directory,”which asks him/her to enter input data. The operator thus enters required data in a specified directory. He/she then comes back to the inquiry message listing screen, selects the inquiry message he/she has just answered, and enters “Done” as the answer. The reply entry manager 211 accepts this answer (step S130) and sends a reply message to the reply message receiver 124 over the network (step S131).

The reply message arrives at the reply message receiver 124 in the server 100 (step S132), which permits the service process 110 to receive a return value as a result of its inquiry API call (step S133). Subsequently, the reply message receiver 124 makes access to the inquiry buffer 122 to retrieve a command relevant to the reply and dispatches the command to the operating system or other appropriate processing facilities (step S134). Then the reply message receiver 124 stores a log record in the log memory 300 (step S135). The service process 110 uses the result of the inquiry as setup parameters or the like and returns to its original service task (step S136).

### Advantages of the Invention

The above-described embodiment of the present invention has the following advantages:

(a) The operator can easily retrieve and browse the records of past inquiry messages and their respective replies. The proposed system allows the operator to consult past examples as necessary, thus helping him/her to find an appropriate answer to the current inquiry message.

(b) The inquiry message listing screen permits the operator to select and answer a particular inquiry seamlessly, thus eliminating the chance of misdirecting an answer to a different inquiry message. More specifically, conventional systems require the operator to specify an inquiry message by entering its identifier or the like. This means that there is a possibility for him/her to enter a wrong identifier, and in that case, his/her answer could be directed to an unintended inquiry. Unlike those conventional systems, the present invention provides a seamless procedure from selecting an inquiry to writing an answer, preventing irrelevant inquiries from being specified as the destination of the answer. The present inventions improves the reliability of computer systems since it is ensued that the operator can write answers to intended inquiries.

(c) Answers are free from syntax errors when they are entered through multiple-choice selection facilities of the proposed system. Besides improving the reliability, this feature of the present invention reduces a psychological burden on the operator. The present invention also makes it easy to develop server programs because the service process does not need to care about whether each received answer is semantically correct or not.

(d) With its timeout handling mechanisms, the proposed system allows service functions to continue, canceling pending inquiries when there is no reply from the operator. This feature of the present invention prevents a server from running out of computer resources (e.g., main memory), which can happen in conventional servers when many service processes go into wait state because of their unanswered inquiries. In other words, the present invention improves the efficiency of service processing by cutting off needless process synchronization.

(e) Inquiry API calls can automatically dispatch a desired command when they are answered. This feature is used to automate post-inquiry processing (e.g., completion notification for a reply) in service tasks.

We have described preferred embodiments of the invention, assuming that the operator uses two separate clients 210 and 220, the former for entering answers and the latter for browsing log records. We do not intend, however, to limit the invention to that specific arrangement of clients. The illustrated two clients 210 and 220 can be implemented on a single computer platform, as mentioned in an earlier section, so that the reply entry manager 211 and log display processor 221 may reside in the same client computer.

The above-described processing mechanisms of the present invention are actually implemented on a computer system with a set of computer programs. Encoded in those computer programs are the functions of the inquiry handler 120, reply entry manager 211, and log display processor 221. The computer system executes such programs to provide the intended functions of the present invention. For the purpose of storage and distribution, the programs are stored in a computer-readable storage medium. Suitable computer-readable storage media include magnetic storage media, optical discs, magneto-optical storage media, and solid state memory devices. Magnetic storage media include hard disk drives (HDD), flexible disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO). Portable storage media, such as DVD and CD-ROM, are used to distribute program products. Network-based distribution of software programs has also become popular, in which master program files stored in a server computer are downloaded to user computers via a network.

Each user computer stores necessary programs in its local storage unit, which have previously been installed from a portable storage media or downloaded from a server computer. The user computer performs intended functions by executing the programs read out of the local storage unit. As an alternative way of program execution, the computer may execute programs, reading out program files directly from a portable storage medium. Another alternative method is that the user computer dynamically downloads programs from a server computer when they are demanded and executes them upon delivery.

To summarize the above discussion, the present invention provides a process of storing log records of inquiries and their corresponding replies and delivering them upon request from a client, so that the operator will be able to browse past inquiries and replies on his/her client console. Using those records as examples, the operator can answer the current inquiries, with reduced possibilities of making a mistake.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A program product that helps service processes receive instructions from an operator, the program product causing a computer system to perform a process comprising the steps of:
(a) storing an inquiry to the operator in an inquiry buffer, upon issuance thereof from a service process;
(b) retrieving the inquiry pending in the inquiry buffer and sending the retrieved inquiry to the first client over a network, in response to a first delivery request from a first client;
(c) forwarding a reply received from the first client to the service process, as well as storing the received reply and corresponding inquiry as a log record in a log memory; and
(d) retrieving log records from the log memory and sending the retrieved log records to a second client on the network, in response to a second delivery request from the second client.

2. The program product according to claim 1, wherein the first and second clients are implemented on a single computer platform.

3. The program product according to claim 1, wherein:
the second delivery request contains search conditions for the log memory; and
said log record retrieving step (d) retrieves log records that match with the search conditions specified by the second client.

4. The program product according to claim 1, wherein:
the second delivery request from the second client requests delivery of a message log record; and
in response to the second delivery request for the message log record, said log record retrieving step (d) retrieves a log record and sends inquiry-related part of the retrieved log record to the second client.

5. The program product according to claim 1, wherein:
the second delivery request from the second client requests delivery of a reply log record; and
in response to the second delivery request for the reply log record, said log record retrieving step (d) retrieves a log record and sends reply-related part of the retrieved log record to the second client.

6. The program product according to claim 5, wherein:
the second delivery request from the second client requests delivery of a reply log record associated with a particular inquiry; and
said log record retrieving step (d) retrieves log records that match with the particular inquiry specified in the second delivery request and sends reply-related part of the retrieved log records to the second client.

7. The program product according to claim 1, wherein the inquiries sent at said inquiry sending step (b) include a list of possible answers to one of the inquiries.

8. The program product according to claim 1, wherein said inquiry sending step (b) consults the log memory before sending the pending inquiry to retrieve records of past replies that were made to inquiries about the same subject as the pending inquiry to be sent, and sends the retrieved records of past replies together with the pending inquiries.

9. The program product according to claim 1, further comprising the step of notifying the service process of cancellation of the pending inquiry if there is no reply to the pending inquiry within a specified timeout period.

10. The program product according to claim 9, wherein:
the timeout period is specified in the pending inquiry sent at said inquiry sending step (b); and
said notifying step notifies the service process of cancellation when expiration time of the pending inquiry is reached, the expiration time being calculated by adding the specified timeout period to issuance time of the pending inquiry.

11. The program product according to claim 10, wherein:
the timeout period is indirectly specified by a timeout period identifier of the pending inquiry; and
said notifying step calculates the expiration time with reference to a predefined timeout period table that associates a plurality of timeout period identifiers with corresponding timeout periods.

12. The program product according to claim 1, further comprising the step of dispatching a command upon receipt of the reply to the pending inquiry, wherein the command is previously associated with the pending inquiry so as to initiate a particular processing task related thereto.

13. The program product according to claim 12, wherein said command dispatching step adds the received reply as a parameter of the command to be dispatched.

14. A method that helps service processes receive instructions from an operator, the method comprising the steps of:
(a) storing an inquiry to the operator in an inquiry buffer, upon issuance thereof from a service process;
(b) retrieving the inquiry pending in the inquiry buffer and sending the retrieved inquiry to the first client over a network, in response to a first delivery request from a first client;
(c) forwarding a reply received from the first client to the service process, as well as storing the received reply and corresponding inquiry as a log record in a log memory; and
(d) retrieving log records from the log memory and sending the retrieved log records to a second client on the network, in response to a second delivery request from the second client.

15. An apparatus that helps service processes receive instructions from an operator, comprising:
an inquiry buffer that stores inquiries;
a log memory that stores records of past inquiries and corresponding replies;
an inquiry receiver that receives an inquiry from the service processes and stores the received inquiry in said inquiry buffer;
an inquiry message sender, responsive to a first delivery request from a first client, which retrieves the inquiry pending in said inquiry buffer and sends the retrieved inquiry to the first client over a network;
a reply message receiver, responsive to a reply received from the first client, which forwards the received reply to the service process, as well as storing the received reply and corresponding inquiry as a log record in said log memory; and
a log record sender responsive to a second delivery request from a second client on the network, which retrieves log records from said log memory and sends the retrieved log records to the second client.

16. A computer-readable storage medium storing a program that helps service processes receive instructions from an operator, the program causing a computer system to perform a process comprising the steps of:
(a) storing an inquiry to the operator in an inquiry buffer, upon issuance thereof from a service process;
(b) retrieving the inquiry pending in the inquiry buffer and sending the retrieved inquiry to the first client over a network, in response to a first delivery request from a first client;
(c) forwarding a reply received from the first client to the service process, as well as storing the received reply and corresponding inquiry as a log record in a log memory; and
(d) retrieving log records from the log memory and sending the retrieved log records to a second client on the network, in response to a second delivery request from the second client.

17. An apparatus that helps service processes receive instructions from an operator, comprising:
inquiry buffer means for storing inquiries;
log memory means for storing records of past inquiries and corresponding replies;
inquiry receiving means for receiving an inquiry from the service processes and stores the received inquiry in said inquiry buffer means;
inquiry message sending means, responsive to a first delivery request from a first client, for retrieving the inquiry pending in said inquiry buffer means and sending the retrieved inquiry to the first client over a network;
reply message receiving means, responsive to a reply received from the first client, for forwarding the received reply to the service process and storing the received reply and corresponding inquiry as a log record in said log memory means; and
log record sending means, responsive to a second delivery request from a second client on the network, for retrieving log records from said log memory means and sending the retrieved log records to the second client.
